(19) United States
(12) Patent Application Publication
(10) Pub. No.: US 2025/0258865 A1
(43) Pub. Date: Aug. 14, 2025

(54) VIDEO DATA PROCESSING METHOD AND APPARATUS, DEVICE, AND READABLE STORAGE MEDIUM

(71) Applicant: BEIJING SOGOU TECHNOLOGY DEVELOPMENT CO., LTD., Beijing (CN)

(72) Inventors: Meng YU, Beijing (CN); Fangxi DENG, Beijing (CN); Dehui PAN, Beijing (CN)

(21) Appl. No.: 19/188,547

(22) Filed: Apr. 24, 2025

Related U.S. Application Data
(63) Continuation of application No. PCT/CN2024/082438, filed on Mar. 19, 2024.

(30) Foreign Application Priority Data
Mar. 20, 2023 (CN) 202310272580.9

(51) Int. Cl. G06F 16/738; G06V 10/74; G06V 10/75; G06V 20/30; G06V 20/40; G06V 20/62; H04N 21/4722

(52) U.S. Cl. CPC G06F 16/738; G06V 10/751; G06V 10/761; G06V 20/30; G06V 20/46; G06V 20/48; G06V 20/635; H04N 21/4722

(57) ABSTRACT

A video data processing method includes obtaining candidate video(s), performing feature extraction on each candidate video to obtain video attribute information corresponding thereto and including work and episode attribute information, obtaining source label information corresponding to each candidate video, classifying the candidate video(s) according to the source label information to obtain an initial video set containing candidate video(s) having same source label information, determining candidate video(s) that have target work attribute information as target video(s), sorting the target video(s) according to episode attribute information corresponding to the target video(s) to obtain sorted video(s), and, if the episode attribute information corresponding thereto satisfies episode legitimacy condition, determining the sorted video(s) as ordered album video(s) and generating a video album set containing the ordered album video(s).

### CROSS-REFERENCE TO RELATED APPLICATIONS

This application is a continuation of International Application No. PCT/CN 2024/082438, filed on Mar. 19, 2024, which claims priority to Chinese Patent Application No. 202310272580.9, filed with the China National Intellectual Property Administration on Mar. 20, 2023 and entitled “VIDEO DATA PROCESSING METHOD AND APPARATUS, DEVICE, AND READABLE STORAGE MEDIUM,” the entire contents of both of which are incorporated by reference.

### FIELD OF THE TECHNOLOGY

This application relates to the technical field of computers, and in particular, to a video data processing method and apparatus, a device, and a readable storage medium.

### BACKGROUND OF THE DISCLOSURE

An editing blogger of a movie or a television show performs editing based on an original movie or television show intellectual property (IP) and adds commentary, with the content focused on a comprehensive explanation of the plot of the movie or the television show, thereby helping a user quickly understand an overall summary of the movie/television show IP.

Therefore, when the user searches for a movie or television show IP using a search engine, a movie and television commentary video related to the movie or television show IP is also recommended in a query result display box. However, due to the simplicity of getting started in video editing, most editing bloggers are not professionals. They lack a fixed editing direction and editing arrangement during video editing so that video information (such as a title or an episode number) may not be added to an edited movie and television commentary video, or the added video information is not accurate enough. However, in a current query mechanism, after movie and television commentary videos associated with a search keyword inputted by the user are queried, these movie and television commentary videos are all mixed in the query result display box. Consequently, movie and television commentary videos with incomplete video information presentation may exist in the query result display box, making it difficult to present a viewing order of the movie and television commentary videos in the same movie or television show IP. Thus, the user needs to click the movie and television commentary videos in the query result display box one by one for viewing, and then the user may determine movie and television commentary videos that the user is interested in and the viewing order of these movie and television commentary videos, leading to a poor presentation effect of the searched movie and television commentary videos.

### SUMMARY

In accordance with the disclosure, there is provided a video data processing method including obtaining one or more candidate videos, performing feature extraction on each of the one or more candidate videos to obtain video attribute information corresponding to each candidate video, and obtaining source label information corresponding to each candidate video. The video attribute information includes work attribute information and episode attribute information. The method further includes classifying the one or more candidate videos according to the source label information to obtain an initial video set that contains at least one candidate video having same source label information, determining one or more candidate videos, in the initial video set, that have target work attribute information as one or more target videos, sorting the one or more target videos according to episode attribute information corresponding to the one or more target videos to obtain one or more sorted videos, and, in response to the episode attribute information corresponding to the one or more sorted videos satisfying an episode legitimacy condition, determining the one or more sorted videos as one or more ordered album videos and generating a video album set containing the one or more ordered album videos.

Also in accordance with the disclosure, there is provided a computer device including a processor, and a memory storing program codes that, when executed by the processor, cause the processor to obtain one or more candidate videos, perform feature extraction on each of the one or more candidate videos to obtain video attribute information corresponding to each candidate video, and obtain source label information corresponding to each candidate video. The video attribute information includes work attribute information and episode attribute information. The program codes further cause the processor to classify the one or more candidate videos according to the source label information to obtain an initial video set that contains at least one candidate video having same source label information, determine one or more candidate videos, in the initial video set, that have target work attribute information as one or more target videos, sort the one or more target videos according to episode attribute information corresponding to the one or more target videos to obtain one or more sorted videos, and, in response to the episode attribute information corresponding to the one or more sorted videos satisfying an episode legitimacy condition, determine the one or more sorted videos as one or more ordered album videos and generate a video album set containing the one or more ordered album videos.

Also in accordance with the disclosure, there is provided a video data processing method including displaying inputted target query data in a query box of an application page, responding to a trigger operation for the target query data to display a recommendation result display region in a query result display box of the application page in response to an intention type of the target query data being a video intention type, and sequentially displaying one or more ordered album videos contained in a target video album set in the recommendation result display region. The target video album set is a video album set with work attribute information or source label information matching the target query data and including ordered album videos corresponding to one or more pieces of work attribute information. A display order of ordered album videos having same work attribute information is according to an episode order of corresponding episode attribute information. The ordered album video in the target video album set is of a commentary video type.

### BRIEF DESCRIPTION OF THE DRAWINGS

To more clearly illustrate the technical solutions in the embodiments of this application, the drawings needed in the descriptions of the embodiments will be briefly introduced below. The drawings described below are only some embodiments of this application, and a person skilled in the art may obtain other drawings according to these drawings without involving any inventive effort.

FIG. 1 is a schematic diagram of a network architecture according to an embodiment of this application.

FIG. 2A is a schematic diagram of a scene for generating a video album set according to an embodiment of this application.

FIG. 2B is a schematic diagram showing a scene for a video query according to an embodiment of this application.

FIG. 3 is a schematic flowchart of a video data processing method according to an embodiment of this application.

FIG. 4 is an overall schematic flowchart of a video clustering mining method according to an embodiment of this application.

FIG. 5 is a schematic flowchart of a video data processing method according to an embodiment of this application.

FIG. 6 is a schematic structural diagram of a video data processing apparatus according to an embodiment of this application.

FIG. 7 is a schematic structural diagram of a computer device according to an embodiment of this application.

FIG. 8 is a schematic structural diagram of another video data processing apparatus according to an embodiment of this application.

FIG. 9 is a schematic structural diagram of another computer device according to an embodiment of this application.

### DESCRIPTION OF EMBODIMENTS

The technical solutions in embodiments of this application are described in the following with reference to the accompanying drawings in the embodiments of this application. The described embodiments are merely some rather than all of the embodiments of this application. All other embodiments obtained by a person skilled in the art based on the embodiments of this application without making inventive efforts shall fall within the protection scope of this application.

Artificial intelligence (AI) involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a nature language processing (NL P) technology, machine learning/deep learning, automatic driving, and intelligent transportation.

CV is a science that studies how to use a machine to “see,” and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. The CV technology generally include technologies such as image processing, image recognition, image semantic understanding, image retrieval, optical character recognition (OCR), video processing, video semantic understanding, video content/behavior recognition, three-dimensional object reconstruction, virtual reality, augmented reality, synchronous positioning and map construction, automatic driving, and intelligent transportation.

Key technologies of the speech technology include an automatic speech recognition technology, a speech synthesis technology, and a voiceprint recognition technology. Making a computer listen, see, speak, and feel is a development direction of human-computer interaction in the future, and speech becomes one of the most favored human-computer interaction modes in the future.

NLP is an important direction in the field of computer science and the field of AI. It studies various theories and methods that can realize effective communication between human and computers using nature languages. NL P is a comprehensive science of linguistics, computer science, and mathematics. Therefore, the research in this field relates to nature languages, i.e., languages daily used by people. Thus, NLP is closely related to the research of linguistics. The NLP technology generally includes technologies such as text processing, semantic understanding, machine translation, robot question-answering, and knowledge graphs.

Solutions provided in the embodiments of this application relate to technologies such as the CV technology, speech technology, and NLP of AI, and are specifically described using the following embodiments.

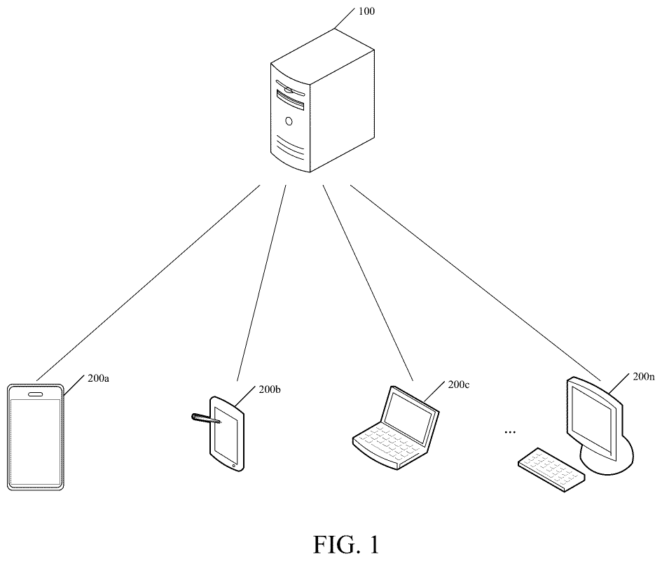

Referring to FIG. 1, FIG. 1 is a schematic diagram of a network architecture according to an embodiment of this application. The network architecture may include a server 100 and a terminal device cluster, and the terminal device cluster may include: a terminal device 200a, a terminal device 200b, a terminal device 200c, . . . , and a terminal device 200n. Any terminal device in the terminal device cluster may have a communication connection with the server 100. For example, the terminal device 200a has a communication connection with the server 100. The foregoing communication connection does not limit a connection manner, and may be a direct or indirect connection in a wired communication manner, may be a direct or indirect connection in a wireless communication manner, or may be a connection in other manners. This is not limited in this application herein.

Each terminal device in the terminal cluster shown in FIG. 1 may be installed with an application client. When the application client runs in each terminal device, the application client may perform data exchange with the server 100 shown in FIG. 1. The application client may be an application client having a query function, such as an instant messaging application, a live broadcast application, a short video application, a video application, a music application, a social application, a shopping application, a game application, a novel application, a payment application, and a browsing application. The application client may be an independent client, or may be an embedded sub-client integrated in a client (such as an instant messaging client, a social client, and a video client). This is not limited herein. Taking the short video application as an example, the server 100 may be configured to respond to a query request transmitted by a terminal device through the short video application to query the query data that is included in the query request and belongs to a video intention type. Therefore, each terminal device may perform data transmission with the server 100 through the short video application. For example, each terminal device may obtain a data flow corresponding to a video album set matching the query data through the short video application.

Taking the terminal device 200a as an example, the terminal device 200a may display an application page through a short video application, and the application page may display a query box. After responding to an input operation, the terminal device 200a may display inputted target query data in the query box. An intention type of the target query data is a video intention type. That is, the target query data may refer to data related to movie and television works such as a movie or a television show, for example, a movie and television IP name, a participant of the movie and television, and a desired editing blogger. Then, the terminal device 200a may respond to a trigger operation for the target query data and transmit a query request including the target query data to the server 100. The server 100 may obtain, from a video album set library, a video album set whose work attribute information or source label information matches the target query data as a target video album set, and then return a data flow corresponding to the target video album set to the terminal device 200a. The work attribute information refers to movie and television IP information. The source label information refers to source information of a video, for example, from which editing blogger or from which website. After receiving the corresponding data flow, the terminal device 200a may display a recommendation result display region in a query result display box of the application page, and sequentially display, in the recommendation result display region, ordered album videos that are of a commentary type and contained in the target video album set. For example, the ordered album video may be a commentary video corresponding to each episode of video in a television show. That is, if the television show has 30 episodes in total, the ordered album videos corresponding to the television show may be 30 commentary videos (for example, one commentary video is a video obtained by editing one of the episodes of the television show), and the 30 commentary videos are presented in the recommendation result display region according to an order of episodes. The video album sets in the video album set library may be generated by the server 100 according to the video data processing method provided in the embodiments of this application.

Specifically, in the embodiments of this application, the server 100 may obtain M to-be-processed videos, M being a positive integer, and then perform feature extraction on the M to-be-processed videos to obtain video attribute information and source label information corresponding to the to-be-processed videos. The to-be-processed video is also referred to as a “candidate video.” The video attribute information includes work attribute information and episode attribute information. Then, the server 100 may add to-be-processed videos having the same source label information to the same video set to obtain an initial video set. In some embodiments, if there is only one to-be-processed video associated with the source label information, an initial video set including only one to-be-processed video may also be generated. Taking target work attribute information (the work attribute information related to the M to-be-processed videos includes the target work attribute information) as an example, the server 100 may determine to-be-processed videos having the target work attribute information in the initial video set as to-be-sorted videos. The to-be-sorted video is also referred to as a “target video.” Finally, the to-be-sorted videos are sorted and filtered according to episode attribute information corresponding to the to-be-sorted videos to obtain ordered album videos, and a video album set containing the ordered album videos is generated. A sorting and filtering process may be as follows: sorting the to-be-sorted videos according to the episode attribute information corresponding to the to-be-sorted videos to obtain sorted videos (i.e., sorting these to-be-sorted videos according to an order of episodes), and further detecting whether episodes (from the episode attribute information) corresponding to these sorted videos are continuous and whether a largest episode in these sorted videos is the same as a total episode of a work to which these sorted videos belong (for example, a television show to which these sorted videos belong); if all of the foregoing determining conditions can be satisfied, determining that the episode attribute information corresponding to the sorted videos satisfies an episode legitimacy condition, and then determining the sorted videos as ordered album videos; and if not all of the foregoing determining conditions are satisfied, filtering these sorted videos. That is, these sorted videos are not recommended as ordered album videos. In this way, the quality of finally displayed ordered album videos may be effectively ensured. Similarly, the server 100 may further sort and filter to-be-sorted videos of other work attribute information in the initial video set according to the foregoing process. If the episode legitimacy condition can be satisfied, corresponding ordered album videos may also be generated. Therefore, the video album set may include ordered album videos corresponding to a plurality of pieces of work attribute information. In some embodiments, when there is only one sorted video corresponding to work attribute information, it may be directly defaulted that the sorted video satisfies the episode legitimacy condition, that is, the sorted video may be directly used as an ordered album video. The server 100 may associatively write the generated video album set and the corresponding work attribute information and source label information into the video album set library for storage to quickly obtain, after determining work attribute information or source label information corresponding to query data after receiving the query data transmitted by the terminal device, a video album set matching the query data, and return a corresponding data flow to the terminal device. According to the embodiments of this application, the episode attribute information corresponding to the ordered album videos contained in the video album set is consecutive, facilitating rapid determining of the viewing order, thereby improving the viewing efficiency.

The method provided in the embodiments of this application may be performed by a computer device, and the computer device includes, but is not limited to, a terminal device or a server. The server may be an independent physical server, may be a server cluster or a distributed system including a plurality of physical servers, or may be a cloud server providing basic cloud computing services such as a cloud database, a cloud service, cloud computing, a cloud function, cloud storage, a network service, cloud communication, a middleware service, a domain name service, a security service, a content delivery network (CDN), a big data and AI platform. The terminal device may be an intelligent terminal that may run an instant messaging application or a social application, such as a smartphone, a tablet computer, a notebook computer, a desktop computer, a palmtop, a mobile internet device (MID), a wearable device (such as a smartwatch or a smart bracelet), a smart television, or an intelligent vehicle. The terminal device and the server may be directly or indirectly connected in a wired or wireless manner. This is not limited in the embodiments of this application herein.

The embodiments of this application may be applied to various scenes, including, but not limited to, scenes such as cloud technologies, AI, intelligent transportation, and block chains.

In a specific implementation of this application, relevant data such as the query data involved need the user's permission or consent when the foregoing embodiments of this application are applied to a specific product or technology. In addition, the collection, use, and processing of relevant data need to comply with relevant laws, regulations, and standards of relevant countries and regions.

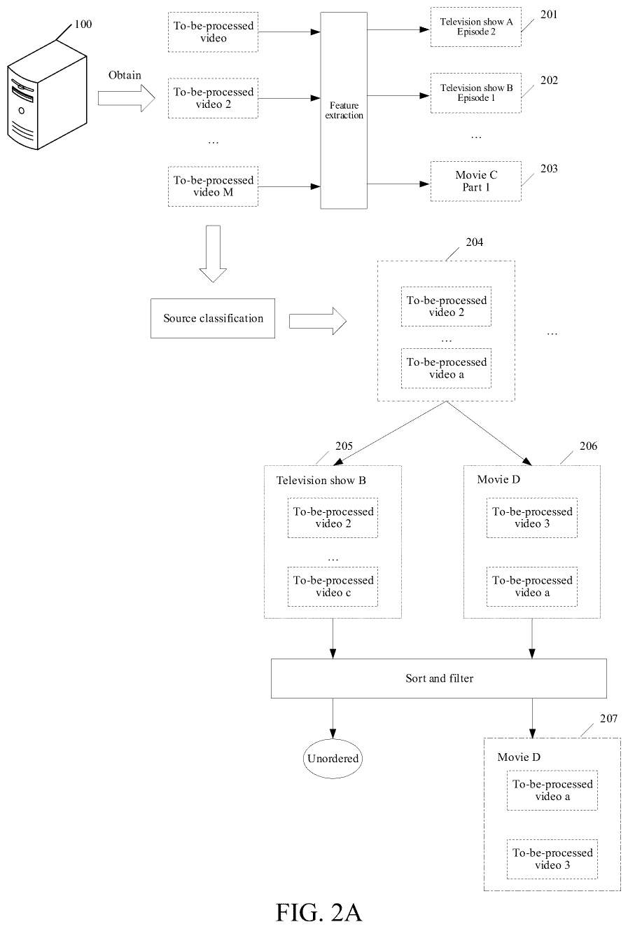

For ease of understanding the foregoing process of generating the video album set and displaying the target video album set when the target query data is queried, FIG. 2A to FIG. 2B are referred to together. The implementation processes of FIG. 2A to FIG. 2B may be performed in the server 100 shown in FIG. 1, may be performed in the terminal device (such as the terminal device 200a, the terminal device 200b, the terminal device 200c, or the terminal device 200n shown in FIG. 1), or may be performed by both the terminal device and the server. This is not limited herein. In the embodiments of this application, performing the implementation processes through the terminal device 200b and the server 100 is taken as an example for description.

Referring to FIG. 2A, FIG. 2A is a schematic diagram showing a scene for generating a video album set according to an embodiment of this application. As shown in FIG. 2A, a server 100 may obtain M to-be-processed videos: a to-be-processed video 1, a to-be-processed video 2, . . . , and a to-be-processed video M. The to-be-processed video may be a movie and television commentary video, i.e., a video that is edited and added with a commentary according to some content of a movie or a television show. The M to-be-processed videos may be videos obtained after the server 100 performs quality screening on a large number of videos that can be obtained. Therefore, the to-be-processed videos may have different sources, contents of movie and television works involved in the to-be-processed videos may be different, and video content presentation modes and video publishing modes corresponding to the to-be-processed videos may also be different. Therefore, the server 100 may classify and collate the M to-be-processed videos to obtain an ordered video album set. Specifically, after obtaining the M to-be-processed videos, the server 100 may first perform feature extraction on the M to-be-processed videos to obtain video attribute information and source label information corresponding to the to-be-processed videos. The video attribute information may include work attribute information and episode attribute information. The work attribute information is configured for describing a movie and television work related to the to-be-processed video, and the episode attribute information is configured for describing which part of content (for example, which episode) of a corresponding movie and television work related to the to-be-processed video. The source label information refers to source information of a video, for example, from which editing blogger or from which website. As shown in FIG. 2A, video attribute information 201 corresponding to the to-be-processed video 1 may be “television show A, episode 2,” indicating that the to-be-processed video 1 is a movie and television commentary video for movie and television content of episode 2 of television show A. Video attribute information 202 corresponding to the to-be-processed video 2 may be “television show B, episode 1,” indicating that the to-be-processed video 2 is a movie and television commentary video for movie and television content of episode 1 of television show B. Video attribute information 203 corresponding to the to-be-processed video M may be “movie C, part 1,” indicating that the to-be-processed video M is a movie and television commentary video for movie and television content of the first half of the movie C.

After obtaining the video attribute information and the source label information of the to-be-processed videos, the server 100 may first perform source classification on the M to-be-processed videos, i.e., may classify the to-be-processed videos according to the source label information. For example, to-be-processed videos having the same source label information are first added to the same initial video set so that the to-be-processed videos in an initial video set have the same source label information. As shown in FIG. 2A, the server 100 may obtain a plurality of initial video sets, for example, an initial video set 204. The initial video set 204 may include a to-be-processed video 2, . . . , and a to-be processed video a. That is, the to-be-processed video 2, . . . , and the to-be-processed video a have the same source label information, and other initial video sets are the same. Then, the server 100 determines to-be-processed videos having the same work attribute information in each initial video set as to-be-sorted videos. Taking the initial video set 204 as an example, as shown in FIG. 2A, suppose work attribute information corresponding to the to-be-processed video 2, . . . , and a to-be-processed video c is a television show B, and work attribute information corresponding to a to-be-processed video 3 and the to-be-processed video a is a movie D so that the server 100 may determine the to-be-processed video 2, . . . , and the to-be-processed video c as to-be-sorted videos 205 and determine the to-be-processed video 3 and the to-be-processed video a as to-be-sorted videos 206, and so on. Then, the server 100 may sort and filter each group of to-be-sorted videos (a group of to-be-sorted videos corresponds to one piece of work attribute information, i.e., to-be-processed videos in a group of to-be-sorted videos all have the same work attribute information), i.e., sorting the group of to-be-sorted videos according to episode attribute information corresponding to the group of to-be-sorted videos, to obtain sorted videos. If episode attribute information corresponding to these sorted videos is continuous and complete, these sorted videos may be determined as ordered album videos, and then a video album set containing the ordered album videos is generated. The video album set may include ordered album videos corresponding to one or more pieces of work attribute information. That is, to-be-sorted videos corresponding to other work attribute information may also generate corresponding ordered album videos in the same mode. As shown in FIG. 2A, suppose after the server 100 sorts the to-be-sorted videos 205, a to-be-processed video that follows the to-be-processed video 2 is the to-be-processed video c. However, episode attribute information corresponding to the to-be-processed video 2 is episode 1, and episode attribute information corresponding to the to-be-processed video c is episode 2. That is, there is no to-be-processed video related to the content of episode 2 of television show B in the to-be-sorted videos 205, and the server 100 may consider that the to-be-sorted videos 205 are unordered and may give up subsequent processing on the to-be-sorted videos 205, i.e., not generating ordered album videos corresponding to the to-be-sorted videos 205. As shown in FIG. 2A, suppose after sorting the to-be-sorted videos 206, the server 100 obtains the to-be-processed video a and the to-be-processed video 3. Episode attribute information corresponding to the to-be-processed video a is part 1, and episode attribute information corresponding to the to-be-processed video 3 is part 2 so that the server 100 may determine that episode attribute information corresponding to the to-be-processed videos in the to-be-sorted videos 206 are continuous and complete. Therefore, the to-be-processed video a and the to-be-processed video 3 may be determined as ordered album videos, and then a video album set 207 including the ordered album videos (i.e., the to-be-processed video a and the to-be-processed video 3) is generated.

When M is large enough, after the M to-be-processed videos are classified and collated, the server 100 may finally obtain a plurality of ordered video album sets. That is, one video album set corresponds to one piece of source label information. One video album set may also contain ordered album videos corresponding to one or more pieces of work attribute information. There may be a plurality of ordered album videos corresponding to one piece of work attribute information, and the plurality of ordered album videos are displayed according to an episode order. When receiving query data for a video intention type, the server 100 may first determine work attribute information or source label information matching the query data, and then return ordered album videos corresponding to the work attribute information or source label information matching the query data to the terminal device.

Further, the terminal device may display inputted target query data in a query box of an application page, and then respond to a trigger operation for the target query data. If an intention type of the target query data is the video intention type, the terminal device displays a recommendation result display region in a query result display box of the application page. The terminal device sequentially displays ordered album videos contained in a target video album set in the recommendation result display region. The target video album set is a video album set whose work attribute information or source label information matches the target query data. A display order of ordered album videos in the target video album set is sorted according to an episode order of episode attribute information corresponding to the ordered album videos. The ordered album video in the target video album set is of a commentary video type. For ease of understanding, referring to FIG. 2B, FIG. 2B is a schematic diagram showing a scene for a video query according to an embodiment of this application. As shown in FIG. 2B, an object having an association relationship with the terminal device 200b is an object 1, and a short video application is integrated and installed on the terminal device 200b. The object 1 may perform data interaction with the server 100 through the short video application of the terminal device 200b. For example, after the object 1 opens the short video application through the terminal device 200b, as shown in FIG. 2B, the terminal device 200b may display an application page 31. The application page 31 includes a query box 311 and a query result display box 312. The query box 311 is configured to provide a query function, and the query result display box 312 is configured to display a query result. Suppose the object 1 wants to watch a movie and television work, the object 1 may perform an input operation through the query box 311. The terminal device 200b may display a query content 311a inputted by the object 1 in the query box 311 of the application page 31. For example, the query content 311a may be “movie D.” After the input of the object 1 is completed, a trigger operation for the query content 311a may be performed. For example, the trigger operation may be a trigger operation for a query control 311b. After responding to the trigger operation for the query content 311a, the terminal device 200b may transmit the query content 311a to the server 100. The server 100 may perform query processing on the query content 311a to obtain query result data, and then return the query result data for the query content 311a to the terminal device 200b. The terminal device 200b may display a query result in the result display box according to the query result data. A feasible process of the query processing is to first determine an intention type of the query content 311a. If it is determined that the intention type of the query content 311a is a video intention type, the server 100, in addition to searching for video data matching the query content 311a from a large amount of obtained video data as first video data, further searches for a video album set matching the query content 311a from a plurality of ordered video album sets found from the scene shown in FIG. 2A, i.e., a video album set matching “movie D,” for example, the video album set 207 shown in FIG. 2A. The server 100 uses video data corresponding to the video album set 207 as the second video data. Then, the server 100 determines the first video data and the second video data as the query result data.

As shown in FIG. 2B, after receiving the query result data, the terminal device 200b displays recommendation result presentation regions, for example, a recommendation result presentation region 312a and a recommendation result presentation region 312b, in the query result display box 312 of the application page 31. Different recommendation result presentation regions are configured to present different video data, and a presentation level of the second video data is higher than that of the first video data. Therefore, the terminal device 200b presents the second video data in the recommendation result presentation region 312a and presents the first video data in the recommendation result presentation region 312b. As shown in FIG. 2B, the terminal device 200b successively displays video covers corresponding to the ordered album videos in the recommendation result display region 312a according to a position order of the ordered album videos contained in the video album set 207 (the position order matches the episode sequence corresponding to the ordered album videos). Since the video album set 207 sequentially contains the to-be-processed video a and the to-be-processed video 3, a video cover 313 is a video cover corresponding to the to-be-processed video a, and a video cover 314 is a video cover corresponding to the to-be-processed video 3. Then, the terminal device 200b presents the video cover corresponding to the first video data in the recommendation result presentation region 312b.

It can be seen that according to the video data processing method provided in the embodiments of this application, when responding to the query data for the video intention type, the terminal device may first display an ordered video album set preferentially, thereby realizing structured ordered video outputting and improving the presentation effect of videos corresponding to the query data. In addition, the ordered album videos are sorted in the video album set according to the episode attribute information and do not need to be clicked and viewed one by one to determine the viewing order of the ordered album videos. Therefore, the presentation effect of searched movie and television commentary videos is improved.

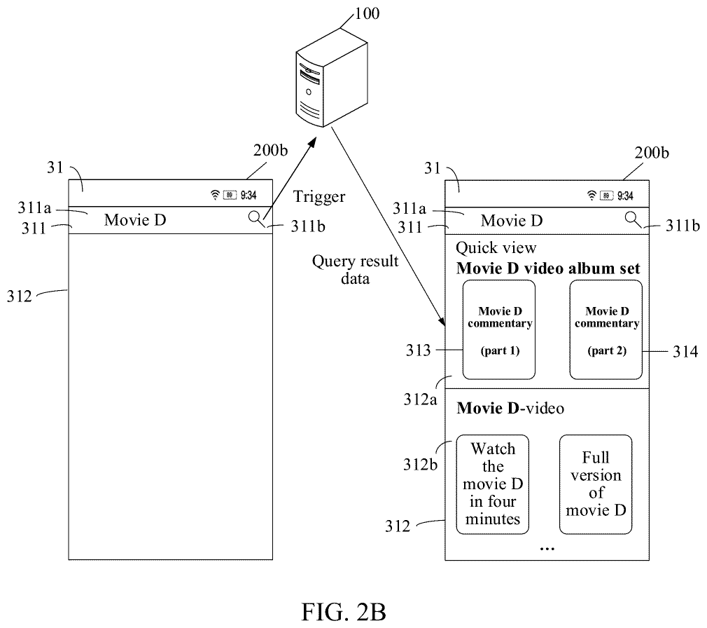

Further, referring to FIG. 3, FIG. 3 is a schematic flowchart of a video data processing method according to an embodiment of this application. The video data processing method may be performed by a computer device, and the computer device may include the terminal device or the server shown in FIG. 1. The method may include the following operation S101 to operation S104.

Operation S101: obtain M to-be-processed videos, M being a positive integer.

Specifically, the to-be-processed video refers to an edited video associated with a movie and television work (i.e., the foregoing movie or television show IP).

In a feasible embodiment, the to-be-processed video may be a movie and television commentary video, i.e., a video generated by an editing blogger by editing some movie and television content in a movie and television work and adding a corresponding commentary (which may be a text commentary, a speech commentary, a video commentary, or the like). The movie and television commentary video can help a user quickly understand a content synopsis of the movie and television work.

Operation S102: perform feature extraction on each of the M to-be-processed videos to obtain video attribute information corresponding to each to-be-processed video, and obtain source label information corresponding to each to-be-processed video, the video attribute information including work attribute information and episode attribute information.

Specifically, the work attribute information refers to movie and television work information corresponding to the to-be-processed video. For example, work attribute information corresponding to a to-be-processed video A may be a name of a television show, such as “BBB,” indicating that video content of the to-be-processed video A belongs to the television show “BBB.” The episode attribute information is configured for characterizing that video content of a to-be-processed video corresponds to movie and television content in which time period of a movie and television work. For example, episode attribute information corresponding to the to-be-processed video A is episode 1 to episode 2, indicating that video content in the to-be-processed video A relates to movie and television content of episode 1 and episode 2 of the television show “BBB.” That is, the to-be-processed video A is generated by editing the movie and television content of episode 1 and episode 2 of the television show “BBB.” The computer device may further obtain the source label information corresponding to the to-be-processed videos. The source label information refers to source information of a video, for example, from which editing blogger or from which website.

Specifically, suppose the M to-be-processed videos include a to-be-processed video Mᵢ, i being a positive integer less than or equal to M. For ease of understanding, taking the to-be-processed video Mᵢ as an example, the feature extraction is described. A feasible implementation process of performing feature extraction on the M to-be-processed videos to obtain video attribute information corresponding to the to-be-processed videos may include: performing work attribute extraction on the to-be-processed video Mᵢ to obtain work attribute information corresponding to the to-be-processed video Mᵢ; and performing episode attribute extraction on the to-be-processed video Mᵢ to obtain episode attribute information corresponding to the to-be-processed video Mᵢ. The work attribute extraction may be performed using different approaches, for example, video frame retrieval, title template matching, and label propagation. The episode attribute extraction may be performed using different approaches, for example, video frame retrieval and title template matching.

Specifically, when the work attribute extraction is performed using the video frame retrieval approach, a feasible implementation process of performing work attribute extraction on the to-be-processed video Mᵢ to obtain work attribute information corresponding to the to-be-processed video Mᵢ may include: sampling the to-be-processed video Mᵢ to obtain a video frame image; performing picture matching on the video frame image against video works in a video work library to obtain picture similarity among the video works in the video work library and the video frame image; determining a video work having highest picture similarity with the video frame image as a target video work; and determining video work attribute information corresponding to the target video work as the work attribute information corresponding to the to-be-processed video Mᵢ if the picture similarity between the video frame image and the target video work is greater than or equal to a picture similarity threshold. The sampling may be sampling at equal time intervals. That is, there may be a plurality of video frame images obtained through sampling, and time intervals between corresponding playing times of adjacent video frame images in the to-be-processed video Mᵢ are equal. For example, a playing duration of the to-be-processed video Mᵢ is 20 s (i.e., 20 seconds), and a sampling time interval is 5 s. Thus, the obtained video frame images are frame images corresponding to 5 s, 10 s, 15 s, and 20 s of the to-be-processed video Mᵢ, respectively. There may be one or more video frame images. The video work refers to an entire movie and television video corresponding to a movie or a television show.

The video frame image may include a video frame image X, and the movie and television works in the movie and television work library may include a movie and television work Y. In this case, in picture frame images contained in the movie and television work Y, a picture frame image having highest similarity with the video frame image X is obtained as a target picture frame image, and the similarity between the target picture frame image and the video frame image X is determined as picture similarity between the movie and television work Y and the video frame image X. Image similarity between the video frame image and the picture frame image may be calculated through image representation vectors corresponding to the two images or may be obtained through other similarity comparison models. This is not limited herein.

In some embodiments, when there are a plurality of video frame images, a feasible implementation process of determining a video work having highest picture similarity with the video frame image may include: traversing the plurality of video frame images, and performing picture matching on a q-th video frame image in the plurality of video frame images against the video works in the video work library to obtain picture similarity among the video works in the video work library and the q-th video frame image, q being a positive integer less than or equal to a number of the plurality of video frame images; obtaining a video work having highest picture similarity with the q-th video frame image as a to-be-determined video work (also referred to as a “determination candidate video work” or a “candidate video work” for determination) corresponding to the q-th video frame image, and marking the to-be-determined video work corresponding to the q-th video frame image; and determining, when to-be-determined video works corresponding to the plurality of video frame images are completely marked, a to-be-determined video work having a largest marking count as the video work having the highest picture similarity with the video frame image. Further, video work attribute information corresponding to the to-be-determined video work having the largest marking count may be determined as the work attribute information corresponding to the to-be-processed video Mᵢ. The to-be-determined video work having the highest similarity determined through a greater number of video frame images may have higher accuracy. That is, the work attribute information corresponding to the determined to-be-processed video Mᵢ may be ensured to be sufficiently accurate.

In some embodiments, when the work attribute extraction is performed using the title template matching approach, a feasible implementation process of performing work attribute extraction on the to-be-processed video Mᵢ to obtain work attribute information corresponding to the to-be-processed video Mᵢ may include: obtaining video title information corresponding to the to-be-processed video Mᵢ; performing structural matching on the video title information against title templates in a title template library to obtain structural similarity among the title templates in the title template library and the video title information; determining a title template having highest structural similarity with the video title information as a target title template; and performing information extraction on the video title information according to the target title template to obtain the work attribute information corresponding to the to-be-processed video Mᵢ if the structural similarity between the video title information and the target title template is greater than or equal to a structural similarity threshold. The title template in the title template library refers to a predefined text template and is configured for extracting work attribute information, i.e., IP information, in the video title information. For example, the title template may include: “IP,” “<IP>,” “[IP],” “IP+digit:,” and “IP+digit.” Suppose video title information C corresponding to the to-be-processed video Mᵢ is “XXX.” After calculating structural similarity between the video title information C and the title templates in the title template library, the computer device may determine that a target title template most similar to the video title information C is “IP.” Therefore, the computer device may perform information extraction on the video title information C according to the target title template to obtain that the work attribute information corresponding to the to-be-processed video Mᵢ is XXX.

Specifically, the label propagation is to predict unmarked node label information from marked node label information using a relationship between samples. When the work attribute extraction is performed using the label propagation approach, a feasible implementation process of performing work attribute extraction on the to-be-processed video Mᵢ to obtain work attribute information corresponding to the to-be-processed video Mᵢ may include: obtaining a k-th sample video in a sample video library through traversing, k being a positive integer; performing picture matching on the to-be-processed video Mᵢ against the k-th sample video to obtain video picture similarity; calculating similarity between the video title information of the to-be-processed video Mᵢ and video title information corresponding to the k-th sample video to obtain video title similarity; obtaining video click logs associated with the to-be-processed video Mᵢ and the k-th sample video, and performing click analysis on the video click logs to obtain video click similarity; determining video similarity between the to-be-processed video Mᵢ and the k-th sample video according to the video picture similarity, the video title similarity, and the video click similarity; weighting video work confidence of the k-th sample video for an associated work according to the video similarity to obtain work confidence of the to-be-processed video Mᵢ for the associated work if the video similarity is greater than a video similarity threshold; and determining video work attribute information corresponding to the associated work as the work attribute information corresponding to the to-be-processed video Mᵢ if the work confidence is greater than or equal to a work confidence threshold. The video work confidence of the k-th sample video for the associated work is configured for characterizing credibility that the k-th sample video belongs to the associated work. The sample video and the to-be-processed video belong to the same type of video. For example, when the to-be-processed video is a movie and television commentary video, the sample video is also a movie and television commentary video. A sample video in the sample video library may be considered as a node and correspondingly has an associated work label (the associated work label may indicate an associated video corresponding to the sample video), and each associated work label has video work confidence (generated by an algorithm when the label is calculated). The video work confidence is configured for characterizing credibility that the sample video belongs to the associated work indicated by the associated work label. When the video work confidence is greater than the work confidence threshold, the sample video belongs to the associated work. A video click log is a log of analyzing a click behavior of a user on a video within a period of time. There may be a plurality of video click logs associated with the to-be-processed video Mᵢ and the k-th sample video. According to these video click logs, the possibility of the user clicking on the to-be-processed video Mᵢ and the k-th sample video simultaneously may be analyzed as the video click similarity. The process of determining video similarity between the to-be-processed video Mᵢ and the k-th sample video according to the video picture similarity, the video title similarity, and the video click similarity may refer to: adding the video picture similarity, the video title similarity, and the video click similarity to obtain an average value, and may also refer to: weighting the video picture similarity, the video title similarity, and the video click similarity, and then adding to obtain an average value. Specifically, the process may be determined according to an actual situation. This is not limited in this application herein.

Specifically, when the episode attribute extraction is performed using the video frame retrieval approach, a feasible implementation process of performing episode attribute extraction on the to-be-processed video Mᵢ to obtain episode attribute information corresponding to the to-be-processed video Mᵢ may include: obtaining a video work having the work attribute information corresponding to the to-be-processed video Mᵢ from the video work library, and taking an obtained video work as a to-be-matched video work (also referred to as a “matching candidate video work” or a “candidate video work” for matching); sampling the to-be-processed video Mᵢ to obtain a video frame image; performing picture matching on the video frame image against video work pictures in the to-be-matched video work to obtain a video work picture matching the video frame image; and determining episode information corresponding to the video work picture matching the video frame image as the episode attribute information corresponding to the to-be-processed video Mᵢ. Picture matching is performed on the video frame image against the to-be-matched video work so that a video work picture of a specific episode, minute, and second in the to-be-matched video work corresponding to the video frame image may be positioned, and then which part of the content of the to-be-matched video work relating to the to-be-processed video Mᵢ may be determined, thereby determining the episode attribute information.

In some embodiments, when the episode attribute extraction is performed using the title template matching approach, a feasible implementation process of performing episode attribute extraction on the to-be-processed video Mᵢ to obtain episode attribute information corresponding to the to-be-processed video Mᵢ may include: performing video layout character recognition on a cover image of the to-be-processed video Mᵢ to obtain cover title information corresponding to the to-be-processed video Mᵢ; performing structural matching on the cover title information against episode templates in an episode template library to obtain structural similarity among the episode templates in the episode template library and the cover title information; determining an episode template having highest structural similarity with the cover title information as a target episode template; and performing information extraction on the cover title information according to the target episode template to obtain the episode attribute information corresponding to the to-be-processed video Mᵢ if the structural similarity between the cover title information and the target episode template is greater than or equal to a structural similarity threshold. The video layout character recognition refers to that a video layout character recognition (VideoLayout_OCR) technology is adopted, and when text information on the cover image is obtained, layout attributes, such as a title, a subtitle, and background text, of the region text may be further recognized, thereby determining the cover title information corresponding to the to-be-processed video Mᵢ according to the layout attributes and the text information. VideoLayout_OCR refers to a technology of combining text detection and an attribute classification task using a three-branch multi-task neural network.

For a specific implementation process when the episode attribute extraction is performed using the title template matching approach, reference may be made to the implementation process when the work attribute extraction is performed using the title template matching approach. In the episode attribute extraction, a used template is the episode template for the episode attribute information. The episode attribute information may include two parts: episode and part. E pisode represents a specific episode, and part represents a specific part, for example, part 1/part 2/part 3 and 1/2/3. Therefore, the episode template may be classified into a pattern type template for extracting pattern information and a part type template for extracting part information. The pattern type template may include: “issue,” “episode,” or “case” followed by “Arabic numeral/Chinese numeral,” for example, issue 1 or episode 2; “issue,” “episode,” or “case” followed by “Arabic numeral“−” or “˜” Arabic numeral,” for example, episode 1-2; “EP” or “Part” followed by an Arabic numeral, for example, EP1 or Part1; or a string with the video title having “finale.” Then, the episode is considered as the last episode. The part type template may include: “(part 1/part 2/part 3),” “part 1/part 2/part 3,” “[part 1/part 2/part 3],” a digit+“|”+a digit, for example, 1/3, a digit+“|”+a digit, for example, 1|3, and a digit+“−”+a digit, for example, 3-1. If the title text can match the part type template, part information, such as the part 1, part 2, and part 3, or 1/3, 2/3, and 3/3, of the video is obtained. The computer device may separately match the two types of episode templates with the cover title information, and the two types of matching does not affect each other. If there is a part type template matching the cover title information, the part information may be extracted. If there is a pattern type template matching the cover title information, the pattern information may be extracted.

Specifically, when the episode attribute extraction is performed using the title template matching approach, in addition to performing episode attribute extraction on the cover title information corresponding to the to-be-processed video Mᵢ, episode attribute extraction may further be performed on the video title information corresponding to the to-be-processed video Mᵢ. The video title information refers to the corresponding title information when the to-be-processed video Mᵢ is published.

Specifically, it can be known from the foregoing description that the work attribute extraction may be performed using approaches such as the video frame retrieval, title template matching, and label propagation, and the episode attribute extraction may be performed using approaches such as the video frame retrieval and title template matching. In an actual extraction process of the work attribute information and the episode attribute information corresponding to the to-be-processed video Mᵢ, the work attribute extraction of the to-be-processed video Mᵢ may be performed using one or more of the foregoing approaches simultaneously, and the episode attribute extraction of the to-be-processed video Mᵢ may be performed using one or more of the foregoing approaches simultaneously. This is not limited in this application herein.

In some embodiments, in the foregoing work attribute extraction process or episode attribute extraction process, available work attribute information or episode attribute information may not be extracted from some to-be-processed videos, and the computer device may determine these to-be-processed videos as invalid to-be-processed videos and directly filter out these invalid to-be-processed videos, i.e., not participating in processing of subsequent operations.

Operation S103: classify the M to-be-processed videos according to the source label information to obtain initial video sets, and determine to-be-processed videos having target work attribute information in the initial video sets as to-be-sorted videos, the to-be-processed videos in the initial video set having the same source label information; and the work attribute information related to the M to-be-processed videos including the target work attribute information.

Specifically, the source label information refers to source information of the to-be-processed video, for example, an author identity (ID, such as identity tag or account) that publishes the to-be-processed video. The computer device may first classify the valid to-be-processed videos according to the source label information, i.e., classifying the M to-be-processed videos according to the source label information. That is, the to-be-processed videos having the same source label information are added to the same initial video set to obtain a plurality of initial video sets, i.e., one initial video set corresponds to a piece of source label information. In other words, the to-be-processed videos in an initial video set have the same source label information. Then, in the initial video set, classification is performed according to the work attribute information, and to-be-processed videos having the same work attribute information are determined as a batch of to-be-sorted videos. For example, to-be-processed videos having the target work attribute information in an initial video set may be determined as a batch of to-be-sorted videos. That is, to-be-processed videos (which all have the same source label information and the same work attribute information) belonging to the same movie and television work in an initial video set are processed together into subsequent ordered album videos. Similarly, to-be-processed videos belonging to another movie and television work in the initial video set are processed together into another group of ordered album videos.

Operation S104: sort the to-be-sorted videos according to episode attribute information corresponding to the to-be-sorted videos to obtain sorted videos, determine the sorted videos as ordered album videos if the episode attribute information corresponding to the sorted videos satisfies an episode legitimacy condition, and generate a video album set containing the ordered album videos, the video album set being configured for being displayed in a query result display box when query data matches work attribute information or source label information corresponding to the ordered album videos.

Specifically, for to-be-sorted videos corresponding to the same work attribute information (for example, the target work attribute information), the computer device may sort the to-be-sorted videos according to the episode attribute information corresponding to the to-be-sorted videos to obtain sorted videos, and then perform continuity detection on the episode attribute information corresponding to the sorted videos to obtain a continuity detection result. If the continuity detection result is an episode continuity result, it may be determined that the episode attribute information corresponding to the sorted videos satisfies an episode legitimacy condition, i.e., the episode legitimacy condition may be a condition on whether the episode attribute information among the sorted videos satisfies the episode continuity result. Further, the sorted videos that satisfy the episode legitimacy condition are determined as ordered album videos, and a video album set containing the ordered album videos is generated. If the continuity detection result is an episode discontinuity result, the sorted videos are determined as unordered videos, and a video album set for the unordered videos does not need to be generated. The sorting may be performed in ascending order from smallest to largest, or in descending order from largest to smallest. This is not limited herein. The continuity detection is to determine whether episode attribute information corresponding to all adjacent sorted videos is continuous. For example, episode attribute information corresponding to a sorted video 1 is episode 1, and episode attribute information corresponding to a sorted video 2 adjacent to the sorted video 1 is episode 3. The two pieces of episode attribute information are discontinuous, and episode 2 is missing in the middle. In this case, the continuity detection result is an episode discontinuity result. It can be seen that the episode continuity result in this case refers to that episode attribute information of each two adjacent sorted videos is episodes adjacent to each other.

In some embodiments, when performing continuity detection, the computer device may further recognize episode attribute information corresponding to a first sorted video in the sorted videos to determine whether the first sorted video is a first work video, i.e., determining whether the episode attribute information corresponding to the first sorted video is episode 1. Similarly, the computer device may obtain total episode information corresponding to work attribute information corresponding to the sorted videos, and then recognize episode attribute information corresponding to a last sorted video in the sorted videos to determine whether the last sorted video is a tail work video, i.e., determining whether episode attribute information corresponding to the last sorted video is equal to the total episode information of a movie and television work to which the last sorted video belongs. If the first sorted video is not the first work video or the last sorted video is not the tail work video, the continuity detection result may be determined as an episode discontinuity result. It can be seen that the episode continuity result in this case refers to that episode attribute information of each two adjacent sorted videos is episodes adjacent to each other, the first sorted video is the first work video (for example, episode 1) of the movie and television work to which the first sorted video belongs, and the last sorted video is the tail work video (for example, the last episode) of the movie and television work to which the last sorted video belongs.

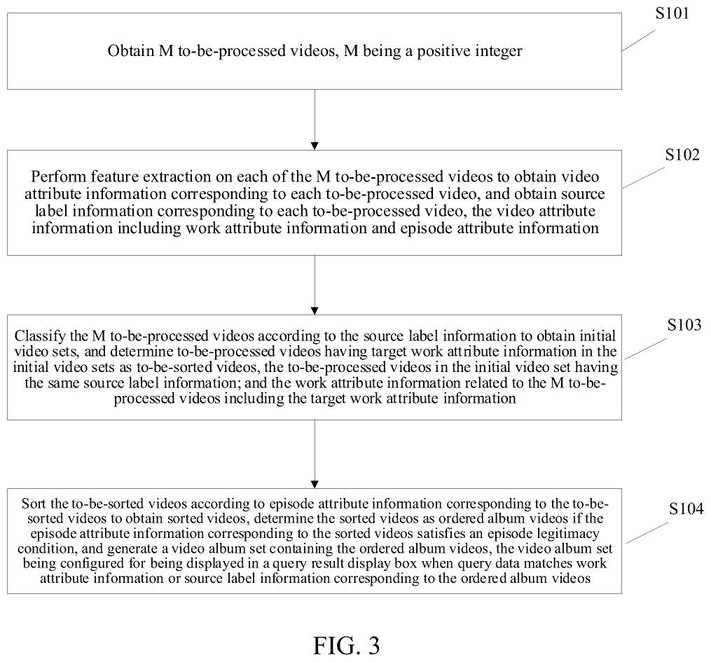

For ease of understanding the foregoing process, the to-be-processed video being a movie and television commentary video to generate a complete video commentary album for a movie or a television show work is taken as an example for description. Referring to FIG. 4, FIG. 4 is an overall schematic flowchart of a video clustering mining method according to an embodiment of this application. As shown in FIG. 4, the overall video clustering mining method includes the following operations.

Operation T1: input M to-be processed videos.

Specifically, the M to-be-processed videos are the M to-be-processed videos in operation S101 in the foregoing embodiment corresponding to FIG. 3.

Then, the computer device needs to extract episode attribute information and work attribute information corresponding to the to-be-processed videos, and obtains source label information corresponding to the to-be-processed videos. The computer device performs operation T2 to operation T9 on each to-be-processed video, and if the work attribute information or the episode attribute information of the to-be-processed video is not finally extracted, determines that the to-be-processed video is an invalid video. For ease of understanding, operation T2 to operation T9 below are all described using a single to-be-processed video as an example.

Operation T2: perform video frame retrieval on the to-be-processed video.

Specifically, for an implementation process of the video frame retrieval, reference may be made to the foregoing description in operation S102 when the work attribute extraction is performed using the video frame retrieval approach, and details are not described herein again.

Operation T3: determine whether work attribute information corresponding to the to-be-processed video is extracted. If the work attribute information is extracted, operation T8 is performed. If the work attribute information is not extracted, operation T4 is performed.

Operation T4: perform template matching on the to-be-processed video.

Specifically, for an implementation process of the template matching, reference may be made to the foregoing description in operation S102 when the work attribute extraction is performed using the template matching approach, and details are not described herein again.

Operation T5: determine whether the work attribute information corresponding to the to-be-processed video is extracted in operation T4. If the work attribute information is extracted, operation T8 is performed. If the work attribute information is not extracted, operation T6 is performed.

Operation T6: perform label propagation on the to-be-processed video.

Specifically, for an implementation process of the label propagation, reference may be made to the foregoing description in operation S102 when the work attribute extraction is performed using the label propagation approach, and details are not described herein again.

Operation T7: determine whether the work attribute information corresponding to the to-be-processed video is extracted in operation T6. If the work attribute information is extracted, operation T8 is performed. If the work attribute information is not extracted, it is determined that the to-be-processed video is invalid.

Operation T8: perform episode attribute information extraction on the to-be-processed video.

Specifically, for an implementation process of the episode attribute information extraction, reference may be made to the foregoing description of the implementation of the episode attribute information extraction in operation S102, and details are not described herein again.

Operation T9: determine whether the episode attribute information corresponding to the to-be-processed video is extracted in operation T8. If the episode attribute information is extracted, operation T10 is performed. If the episode attribute information is not extracted, it is determined that the to-be-processed video is invalid.

Operation T10: perform album aggregation on a valid to-be-processed video.

Specifically, the valid to-be-processed video is first classified according to an author ID (i.e., the source label information in FIG. 3), and then the same video IP (i.e., the work attribute information) under the same author is classified. In this way, a valid to-be-sorted video of a unique video author+video IP may be obtained. For a specific implementation process of operation T10, reference may be made to the foregoing description of operation S103.

Operation T11: generate a video album.

Specifically, for the implementation of operation T11, reference may be made to the foregoing description of operation S104 in the embodiment corresponding to FIG. 3, and details are not described herein again.

It can be seen that the ordered album videos contained in the video album set obtained through the method provided in the embodiments of this application correspond to the same work attribute information and source label information. When the query data matches the same work attribute information and source label information corresponding to the ordered album videos, the video album set may be displayed in the query result display box, thereby realizing structured video outputting and improving the presentation effect of videos corresponding to the query data. In addition, the ordered album videos are sorted in the video album set according to the episode attribute information and do not need to be clicked and viewed one by one to determine the viewing order of the ordered album videos. Therefore, the presentation effect of searched movie and television commentary videos is improved. In addition, in this application, the work attribute information and the episode attribute information of the to-be-processed videos may be mined more accurately through approaches such as the video frame retrieval, title template matching, and label propagation, thereby ensuring the accuracy of generated ordered album videos. In addition, since there is a progressive mining mechanism such as the video frame retrieval, title template matching, and label propagation, the work attribute information and the episode attribute information may be mined from more to-be-processed videos, thereby ensuring the number of ordered album videos. In addition, determination and detection are performed through the episode legitimacy condition to better ensure that episodes of ordered album videos corresponding to one movie and television work are continuous and complete, thereby further ensuring the accuracy of the ordered album videos.

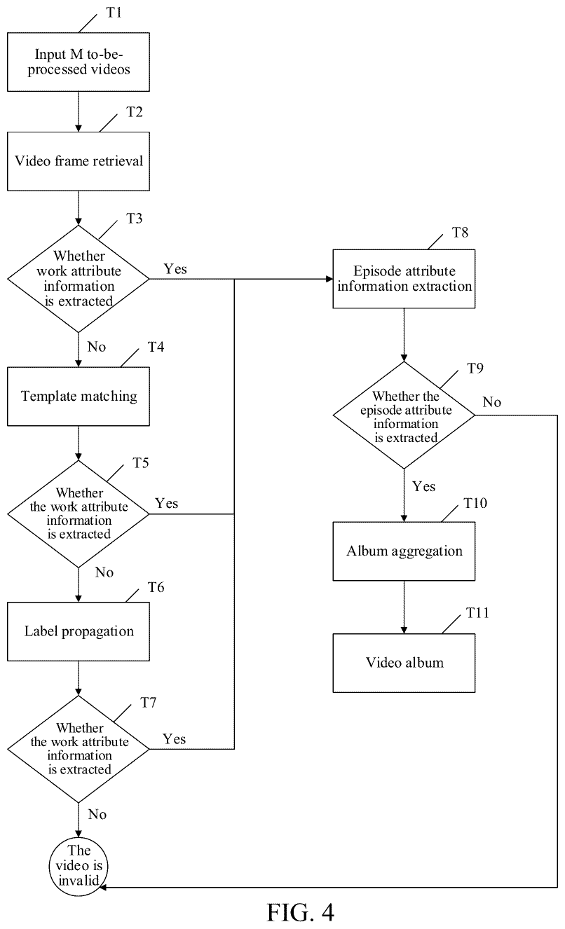

Further, referring to FIG. 5, FIG. 5 is a schematic flowchart of a video data processing method according to an embodiment of this application. The video data processing method may be performed by a computer device, and the computer device may include the terminal device or the server shown in FIG. 1. The method may include the following operation S201 to operation S204.

Operation S201: perform quality screening on a first initial video set to obtain M to-be-processed videos, the first initial video set including at least two initial videos.

Specifically, to generate a video album set of better quality, quality screening may be first performed on the videos in the first initial video set to filter out some videos of unqualified quality. The quality screening may include black border detection, watermark detection, and definition recognition.

The black border detection requires that a black border ratio of the initial video cannot exceed a particular range. Otherwise, a content picture ratio is excessively small, affecting viewing experience of the user. The black border detection is mainly to perform frame extraction in the initial video through a fixed sampling rate, then set a black border ratio threshold to perform image binarization, and detect a ratio of continuous black pixels to the width/height of the video to filter the initial video. The black border ratio threshold may be determined according to the length and the width of the video. For example, a black border ratio threshold corresponding to a short video may be 1/3, and a black border ratio threshold corresponding to a small video may be 2/3. The short video is a video in which the width of the video is greater than the height of the video. The small video is a video in which the width of the video is less than the height of the video.

The watermark detection requires that there is no excessively large watermark in the initial video. Otherwise, the main body of the video picture is seriously blocked. The watermark detection is mainly to obtain a candidate region by comparing pixels between continuous frames of a video, then perform binarization on frame images in the video through edge detection, mean filtering, and an Otsu threshold method, and then use a connected domain algorithm and a clustering algorithm to obtain a region having a largest connected area through screening, i.e., considering the region as a watermark portion. Then, the watermark area is compared with the picture area. If the watermark area is more than 1/25 of the picture area, the watermark is excessively large, and blocking exists.

The definition recognition refers to calculating gradients among pixels in the video picture, counting a global gradient mean value, and then normalizing to obtain a definition. The definition may be set to a value of 0 to 4, and 4 indicates the highest definition. In this case, a definition threshold may be set to 2, i.e., the definition corresponding to the initial video may not be lower than 2.

The computer device may select one or more processing approaches of black border detection, watermark detection, or definition recognition to perform quality screening on the videos in the first initial video set, or may add other quality screening processing according to an actual situation.

Specifically, if the black border detection, watermark detection, and definition recognition are simultaneously used, a feasible implementation process of performing quality screening on a first initial video set to obtain M to-be-processed videos may include: obtaining a first initial video set; performing black border detection on the first initial video set to obtain black border ratios corresponding to initial videos in the first initial video set; filtering out initial videos with black border ratios greater than a black border ratio threshold from the first initial video set to obtain a second initial video set; performing watermark detection on the second initial video set to obtain watermark area ratios corresponding to the initial videos in the second initial video set; filtering out initial videos with watermark area ratios greater than a watermark area ratio threshold from the second initial video set to obtain a third initial video set; performing definition recognition on the third initial video set to obtain definitions corresponding to the initial videos in the third initial video set; and filtering out initial videos with definitions below a definition threshold from the third initial video set to obtain the M to-be-processed videos. The initial videos are filtered layer by layer through three filtering approaches so that the video quality of the remaining M to-be-processed videos is ensured, and the album quality of the finally generated video album set may be improved.

Operation S202: perform feature extraction on the M to-be-processed videos to obtain video attribute information corresponding to each to-be-processed video, and obtain source label information corresponding to each to-be-processed video, the video attribute information including work attribute information and episode attribute information.

Specifically, for an implementation process of operation S202, reference may be made to the foregoing implementation process of operation S102, and details are not described herein again.

Operation S203: classify the M to-be-processed videos according to the source label information to obtain initial video sets, and determine to-be-processed videos having target work attribute information in the initial video sets as to-be-sorted videos, the to-be-processed videos in the initial video set having the same source label information; and the work attribute information related to the M to-be-processed videos including the target work attribute information.

Specifically, for an implementation process of operation S203, reference may be made to the foregoing implementation process of operation S103, and details are not described herein again.

Operation S204: sort the to-be-sorted videos according to episode attribute information corresponding to the to-be-sorted videos to obtain sorted videos, determine the sorted videos as ordered album videos if the episode attribute information corresponding to the sorted videos satisfies an episode legitimacy condition, and generate a video album set containing the ordered album videos, the video album set being configured for being displayed in a query result display box when query data matches work attribute information or source label information corresponding to the ordered album videos.

Specifically, the to-be-sorted videos are sorted according to the episode attribute information corresponding to the to-be-sorted videos to obtain the sorted videos. Continuity detection is performed on the episode attribute information corresponding to the sorted videos to obtain a continuity detection result. Video version recognition is performed on the sorted videos according to a target work knowledge graph to obtain a target video version corresponding to the sorted videos if the continuity detection result is an episode continuity result. The target work knowledge graph is a work knowledge graph associated with work attribute information corresponding to the sorted videos. In the target work knowledge graph, total episode information corresponding to the sorted videos is determined according to the target video version It is determined that the episode attribute information corresponding to the sorted videos satisfies the episode legitimacy condition if largest episode attribute information in the episode attribute information corresponding to the sorted videos is the same as the total episode information, thereby determining the sorted videos as ordered album videos. A video album set containing the ordered album videos is generated. In this case, the episode legitimacy condition not only requires that episodes of the sorted videos are continuous, but also requires that the last episode in the sorted videos corresponds to the last episode of the movie and television work to which the sorted videos belong, thereby better ensuring the accuracy of the ordered album videos. For an implementation process of the continuity detection, reference may be made to the foregoing description of operation S104 in the embodiment corresponding to FIG. 3. The knowledge graph is a semantic network that describes various entities and concepts existing in the real world and relationships among the entities and concepts. The work knowledge graph is a semantic network that describes a movie and television work and relationships among various entities associated with the movie and television work.

In some embodiments, when the episode attribute information corresponding to the sorted videos includes episode information or part information, after it is determined that the continuity detection result is the episode continuity result, whether a first video that ranks first in the sorted videos is the first video may be checked first. That is, if the first video has only the episode information, whether the episode information of the first video is 1 is determined, and if the episode information of the first video is not 1, the sorted videos are determined as invalid videos. Then, whether the first video has part information is determined. If the first video has the part information, it needs to be satisfied that the part information is 1 or “part 1.” Otherwise, the sorted videos are invalid videos. If the first video that ranks first in the sorted videos is the first video, whether the tail video that is the last in the sorted videos has part information is checked, and if the part information exists, whether the part information is the last part is checked. If the part information includes “part 1” or “part 2” or only a digit “1,” it is determined that the tail video is not the last part, and the sorted videos are determined as invalid videos. In addition, if the part information corresponding to the sorted videos is of an N/M type, it is also necessary to determine whether N of the last video in the sorted videos, i.e., the tail video, is equal to M, such as 4/4. If N is not equal to M, it is determined that the tail video is not the last part, and the sorted videos are invalid videos. Then, the computer device may further check whether more than one “finale” occurs in title names of videos in the sorted videos. If finales occur multiple times and there is no part information, it is determined that the sorted videos are invalid videos. If the computer device determines that the sorted videos are invalid videos, a corresponding video album set does not need to be generated.

Specifically, the target work knowledge graph may contain one or more video versions and video object lists corresponding to the video versions. A feasible implementation process of performing video version recognition on the sorted videos to obtain a target video version corresponding to the sorted videos may include: performing object recognition on the sorted video to obtain a plurality of video objects contained in the sorted video and occurrence durations corresponding to the video objects; obtaining R target video objects from the plurality of video objects according to a duration order of the occurrence durations corresponding to the video objects, R being a positive integer; determining object coincidence degrees among the R target video objects and the video object lists in the target work knowledge graph, the object coincidence degree being a coincidence degree among video objects contained in a video object list and the R target video objects; and determining a video version corresponding to a video object list having a largest object coincidence degree as the target video version corresponding to the sorted video. The same movie and television work may have different actors for performance. In this case, the same movie and television work has a plurality of video versions, and actor lists corresponding to movie and television works in different video versions are very different. Therefore, the R target video objects having a largest occurrence count or having a longest occurrence duration in the sorted video may be recognized first through an object recognition technology, and then object coincidence degrees among the R target video objects and actor lists (i.e., video object lists) corresponding to the video versions in the target work knowledge graph corresponding to the movie and television work are calculated. For example, the R target video objects may be used as a to-be-matched actor list, and then an object coincidence degree between the to-be-matched actor list and an actor list corresponding to a video version in the target work knowledge graph may be calculated. A video version corresponding to a video object list having the largest object coincidence degree is the target video version corresponding to the sorted video.

After determining the target video version, the computer device may further obtain total episode information corresponding to the target video version through the target work knowledge graph, and then compare the total episode information with the largest episode attribute information in the episode attribute information corresponding to the sorted videos to determine whether the sorted videos are finished. If the largest episode attribute information is not less than the total episode information corresponding to the target video version, the sorted videos may be determined as ordered video albums.

In some embodiments, if the largest episode attribute information is less than the total episode information corresponding to the target video version, the computer device may further determine whether a time difference between current system time and show time of the target video version exceeds 90 days. If the time difference exceeds 90 days, the sorted videos are determined as invalid videos. If the time difference is less than 90 days, the sorted videos may still be determined as ordered video albums.

Specifically, when there are at least two ordered album videos, a feasible implementation process of generating a video album set containing the ordered album videos may include: traversing the at least two ordered album videos to sequentially obtain a j-th ordered album video, j being a positive integer; performing correlation matching on a video cover corresponding to the j-th ordered album video and a video title corresponding to the j-th ordered album video to obtain a correlation matching result; determining the video cover corresponding to the j-th ordered album video as an album video cover corresponding to the j-th ordered album video if the correlation matching result is a correlation matching success result; performing, if the correlation matching result is a correlation matching failure result, video frame screening on the j-th ordered album video to obtain a video frame picture matching the video title corresponding to the j-th ordered album video, and determining the video frame picture as the album video cover corresponding to the j-th ordered album video; and generating, when obtaining album video covers corresponding to the ordered album videos, the video album set containing the album video covers corresponding to the ordered album videos. In short, to have a better presentation effect, the computer device may further select an album video cover for each ordered album video in the video album set, and when the video album set is finally presented, the computer device does not present an original video cover of the ordered album video, but presents the album video cover corresponding to the ordered album video. A feasible implementation process of performing video frame screening on the j-th ordered album video to obtain a video frame picture matching the video title corresponding to the j-th ordered album video, and determining the video frame picture as the album video cover corresponding to the j-th ordered album video may include: screening out the first three (or may be any other number, this is not limited) video frame images most related to the video title corresponding to the j-th ordered album video through an image-text correlation model, then selecting a video frame image with the highest quality through an aesthetic model, and using the video frame image as the album video cover corresponding to the j-th ordered album video.

The video data processing method provided in the embodiments of this application may help a user understand a movie or a television show simply, completely, quickly, and concisely so that a problem that subsequent relevant content cannot be found or the content is missing when the user searches for a favored video is resolved, and problems that the video title does not match the content and the video quality is low are also resolved, thereby improving the overall user experience.

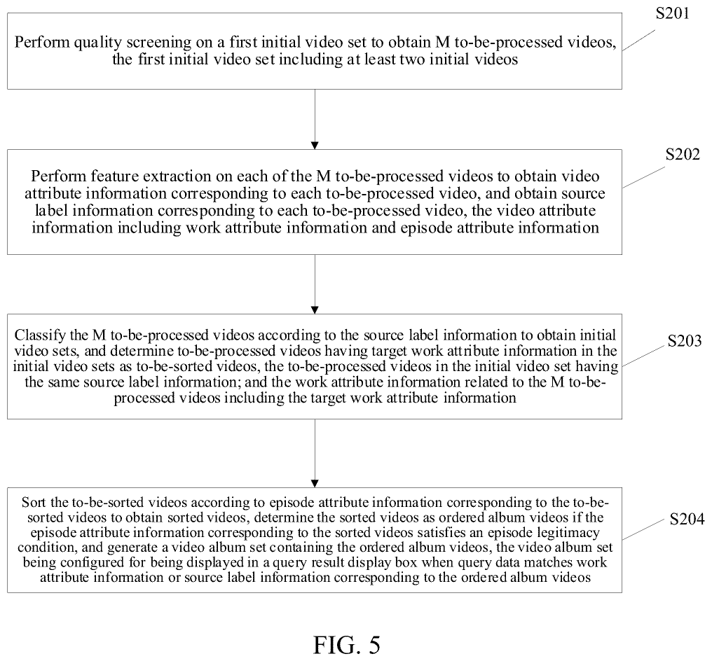

Referring to FIG. 6, FIG. 6 is a schematic structural diagram of a video data processing apparatus according to an embodiment of this application. The video data processing apparatus may be a computer program (including a program code) running on a computer device. For example, the video data processing apparatus is application software. The apparatus may be configured to perform corresponding operations in the video data processing method provided by the embodiments of this application. As shown in FIG. 6, a video data processing apparatus 1 may include: an obtaining module 11, a feature extraction module 12, a video determining module 13, and a generation module 14.

The obtaining module 11 is configured to obtain M to-be-processed videos, M being a positive integer.

The feature extraction module 12 is configured to perform feature extraction on the M to-be-processed videos to obtain video attribute information corresponding to the to-be-processed videos and obtain source label information corresponding to the to-be-processed videos, the video attribute information including work attribute information and episode attribute information.

The video determining module 13 is configured to classify the M to-be-processed videos according to the source label information to obtain initial video sets and determine to-be-processed videos having target work attribute information in the initial video sets as to-be-sorted videos, the to-be-processed videos in the initial video set having the same source label information; and the work attribute information related to the M to-be-processed videos including the target work attribute information.

The generation module 14 is configured to sort the to-be-sorted videos according to episode attribute information corresponding to the to-be-sorted videos to obtain sorted videos, determine the sorted videos as ordered album videos if the episode attribute information corresponding to the sorted videos satisfies an episode legitimacy condition, and generate a video album set containing the ordered album videos, the video album set being configured for being displayed in a query result display box when query data matches work attribute information or source label information corresponding to the ordered album videos.

For the specific functional implementations of the obtaining module 11, the feature extraction module 12, the video determining module 13, and the generation module 14, reference may be made to the descriptions of operation S101 to operation S104 in the embodiment corresponding to FIG. 3, and details are not described herein again.

The M to-be-processed videos include a to-be-processed video Mᵢ, i being a positive integer less than or equal to M.

The feature extraction module 12 includes: a first extraction unit 121 and a second extraction unit 122.

The first extraction unit 121 is configured to perform work attribute extraction on the to-be-processed video Mᵢ to obtain work attribute information corresponding to the to-be-processed video Mᵢ.

The second extraction unit 122 is configured to perform episode attribute extraction on the to-be-processed video Mᵢ to obtain episode attribute information corresponding to the to-be-processed video Mᵢ.

For the specific functional implementations of the first extraction unit 121 and the second extraction unit 122, reference may be made to the description of operation S102 in the embodiment corresponding to FIG. 3, and details are not described herein again.

The first extraction unit 121 includes: a frame retrieval subunit 1211.

The frame retrieval subunit 1211 is configured to sample the to-be-processed video Mᵢ to obtain a video frame image.

The frame retrieval subunit 1211 is further configured to perform picture matching on the video frame image against video works in a video work library to obtain picture similarity among the video works in the video work library and the video frame image.

The frame retrieval subunit 1211 is further configured to determine a video work having highest picture similarity with the video frame image as a target video work.

The frame retrieval subunit 1211 is further configured to determine video work attribute information corresponding to the target video work as the work attribute information corresponding to the to-be-processed video Mᵢ if the picture similarity between the video frame image and the target video work is greater than or equal to a picture similarity threshold.

For the specific functional implementation of the frame retrieval subunit 1211, reference may be made to the description of operation S102 in the embodiment corresponding to FIG. 3, and details are not described herein again.

Alternatively, the first extraction unit 121 may be specifically configured to sample the to-be-processed video Mᵢ at equal intervals to obtain a plurality of video frame images, traverse the plurality of video frame images, and perform picture matching on a q-th video frame image in the plurality of video frame images against the video works in the video work library to obtain picture similarity among the video works in the video work library and the q-th video frame image, q being a positive integer less than or equal to a number of the plurality of video frame images.

The first extraction unit 121 is specifically configured to obtain a video work having highest picture similarity with the q-th video frame image as a to-be-determined video work corresponding to the q-th video frame image, mark the to-be-determined video work corresponding to the q-th video frame image, and determine, when to-be-determined video works corresponding to the plurality of video frame images are completely marked, video work attribute information corresponding to a to-be-determined video work having a largest marking count as the work attribute information corresponding to the to-be-processed video Mᵢ.

The first extraction unit 121 includes: a template matching subunit 1212.

The template matching subunit 1212 is configured to obtain video title information corresponding to the to-be-processed video Mᵢ.

The template matching subunit 1212 is further configured to perform structural matching on the video title information against title templates in a title template library to obtain structural similarity among the title templates in the title template library and the video title information.

The template matching subunit 1212 is further configured to determine a title template having highest structural similarity with the video title information as a target title template.

The template matching subunit 1212 is further configured to perform information extraction on the video title information according to the target title template to obtain the work attribute information corresponding to the to-be-processed video Mᵢ if the structural similarity between the video title information and the target title template is greater than or equal to a structural similarity threshold.

For the specific functional implementation of the template matching subunit 1212, reference may be made to the description of operation S102 in the embodiment corresponding to FIG. 3, and details are not described herein again.

The first extraction unit 121 includes: a propagation matching subunit 1213.

The propagation matching subunit 1213 is configured to obtain a k-th sample video in a sample video library through traversing, k being a positive integer.

The propagation matching subunit 1213 is further configured to perform picture matching on the to-be-processed video Mᵢ against the k-th sample video to obtain video picture similarity.

The propagation matching subunit 1213 is further configured to calculate similarity between the video title information of the to-be-processed video Mᵢ and video title information corresponding to the k-th sample video to obtain video title similarity.

The propagation matching subunit 1213 is further configured to obtain video click logs associated with the to-be-processed video Mᵢ and the k-th sample video and perform click analysis on the video click logs to obtain video click similarity.

The propagation matching subunit 1213 is further configured to determine video similarity between the to-be-processed video Mᵢ and the k-th sample video according to the video picture similarity, the video title similarity, and the video click similarity.

The propagation matching subunit 1213 is further configured to weight video work confidence of the k-th sample video for an associated work according to the video similarity to obtain work confidence of the to-be-processed video Mᵢ for the associated work if the video similarity is greater than a video similarity threshold, the video work confidence of the k-th sample video for the associated work being configured for characterizing credibility that the k-th sample video belongs to the associated work.

The propagation matching subunit 1213 is further configured to determine video work attribute information corresponding to the associated work as the work attribute information corresponding to the to-be-processed video Mᵢ if the work confidence is greater than or equal to a work confidence threshold.

For the specific functional implementation of the propagation matching subunit 1213, reference may be made to the description of operation S102 in the embodiment corresponding to FIG. 3, and details are not described herein again.

The second extraction unit 122 includes: a frame matching subunit 1221.

The frame matching subunit 1221 is configured to obtain a video work having the work attribute information corresponding to the to-be-processed video Mᵢ from the video work library and take an obtained video work as a to-be-matched video work.

The frame matching subunit 1221 is further configured to sample the to-be-processed video Mᵢ to obtain the video frame image.

The frame matching subunit 1221 is further configured to perform picture matching on the video frame image against video work pictures in the to-be-matched video work to obtain a video work picture matching the video frame image.

The frame matching subunit 1221 is further configured to determine episode information corresponding to the video work picture matching the video frame image as the episode attribute information corresponding to the to-be-processed video Mᵢ.

For the specific functional implementation of the frame matching subunit 1221, reference may be made to the description of operation S102 in the embodiment corresponding to FIG. 3, and details are not described herein again.

The second extraction unit 122 includes: a title matching subunit 1222.

The title matching subunit 1222 is configured to perform video layout character recognition on a cover image of the to-be-processed video Mᵢ to obtain cover title information corresponding to the to-be-processed video Mᵢ.

The title matching subunit 1222 is further configured to perform structural matching on the cover title information against episode templates in an episode template library to obtain structural similarity among the episode templates in the episode template library and the cover title information.

The title matching subunit 1222 is further configured to determine an episode template having highest structural similarity with the cover title information as a target episode template.

The title matching subunit 1222 is further configured to perform information extraction on the cover title information according to the target episode template to obtain the episode attribute information corresponding to the to-be-processed video Mᵢ if the structural similarity between the cover title information and the target episode template is greater than or equal to a structural similarity threshold.

For the specific functional implementation of the title matching subunit 1222, reference may be made to the description of operation S102 in the embodiment corresponding to FIG. 3, and details are not described herein again.

The generation module 14 includes: a sorting unit 141, a detection unit 142, a version recognition unit 143, an episode determining unit 144, a video determining unit 145, and an album generation unit 146.

The sorting unit 141 is configured to sort the to-be-sorted videos according to episode attribute information corresponding to the to-be-sorted videos to obtain sorted videos.

The detection unit 142 is configured to perform continuity detection on the episode attribute information corresponding to the sorted videos to obtain a continuity detection result.

The version recognition unit 143 is configured to perform video version recognition on the sorted video according to a target work knowledge graph to obtain a target video version corresponding to the sorted video if the continuity detection result is an episode continuity result, the target work knowledge graph is a work knowledge graph associated with work attribute information corresponding to the sorted videos.

The episode determining unit 144 is configured to determine, in the target work knowledge graph, total episode information corresponding to the sorted videos according to the target video version.

The video determining unit 145 is configured to determine that the episode attribute information corresponding to the sorted videos satisfies the episode legitimacy condition if largest episode attribute information in the episode attribute information corresponding to the sorted videos is the same as the total episode information.

The video determining unit 145 is further configured to determine the sorted videos as ordered album videos if the episode attribute information corresponding to the sorted videos satisfies an episode legitimacy condition.

The album generation unit 146 is configured to generate a video album set containing the ordered album videos.

For the specific functional implementations of the sorting unit 141, the detection unit 142, the version recognition unit 143, the episode determining unit 144, the video determining unit 145, and the album generation unit 146, reference may be made to the description of operation S204 in the embodiment corresponding to FIG. 5, and details are not described herein again.

The target work knowledge graph contains one or more video versions and video object lists corresponding to the video versions.

The version recognition unit 143 includes: a coincidence determining subunit 1431 and a version determining subunit 1432.

The coincidence determining subunit 1431 is configured to perform object recognition on the sorted video to obtain a plurality of video objects contained in the sorted video and occurrence durations corresponding to the video objects.

The coincidence determining subunit 1431 is further configured to obtain R target video objects from the plurality of video objects according to a duration order of the occurrence durations corresponding to the video objects, R being a positive integer.

The coincidence determining subunit 1431 is further configured to determine object coincidence degrees among the R target video objects and the video object lists in the target work knowledge graph, the object coincidence degree being a coincidence degree among video objects contained in a video object list and the R target video objects.

The version determining subunit 1432 is configured to determine a video version corresponding to a video object list having a largest object coincidence degree as the target video version corresponding to the sorted video.

For the specific functional implementations of the coincidence determining subunit 1431 and the version determining subunit 1432, reference may be made to the description of operation S204 in the embodiment corresponding to FIG. 5, and details are not described herein again.

There are at least two ordered album videos.

The album generation unit 146 includes: a cover determining subunit 1461 and a generation subunit 1462.

The cover determining subunit 1461 is configured to traverse the at least two ordered album videos to sequentially obtain a j-th ordered album video, j being a positive integer.

The cover determining subunit 1461 is further configured to perform correlation matching on a video cover corresponding to the j-th ordered album video and a video title corresponding to the j-th ordered album video to obtain a correlation matching result.

The cover determining subunit 1461 is further configured to determine the video cover corresponding to the j-th ordered album video as an album video cover corresponding to the j-th ordered album video if the correlation matching result is a correlation matching success result.

The cover determining subunit 1461 is further configured to perform, if the correlation matching result is a correlation matching failure result, video frame screening on the j-th ordered album video to obtain a video frame picture matching the video title corresponding to the j-th ordered album video, and determine the video frame picture as the album video cover corresponding to the j-th ordered album video.

The generation subunit 1462 is configured to generate, when obtaining album video covers corresponding to the ordered album videos, the video album set containing the album video covers corresponding to the ordered album videos.

For the specific functional implementations of the cover determining subunit 1461 and the generation subunit 1462, reference may be made to the description of operation S204 in the embodiment corresponding to FIG. 5, and details are not described herein again.

The foregoing video data processing apparatus 1 further includes: a filtering module 15.

The filtering module 15 is configured to obtain a first initial video set.

The filtering module 15 is further configured to perform black border detection on the first initial video set to obtain black border ratios corresponding to initial videos in the first initial video set.

The filtering module 15 is further configured to filter out initial videos with black border ratios greater than a black border ratio threshold from the first initial video set to obtain a second initial video set.

The filtering module 15 is further configured to perform watermark detection on the second initial video set to obtain watermark area ratios corresponding to the initial videos in the second initial video set.

The filtering module 15 is further configured to filter out initial videos with watermark area ratios greater than a watermark area ratio threshold from the second initial video set to obtain a third initial video set.

The filtering module 15 is further configured to perform definition recognition on the third initial video set to obtain definitions corresponding to the initial videos in the third initial video set.

The filtering module 15 is further configured to filter out initial videos with definitions below a definition threshold from the third initial video set to obtain the M to-be-processed videos.

For the specific functional implementation of the filtering module 15, reference may be made to the description of operation S204 in the embodiment corresponding to FIG. 5, and details are not described herein again.

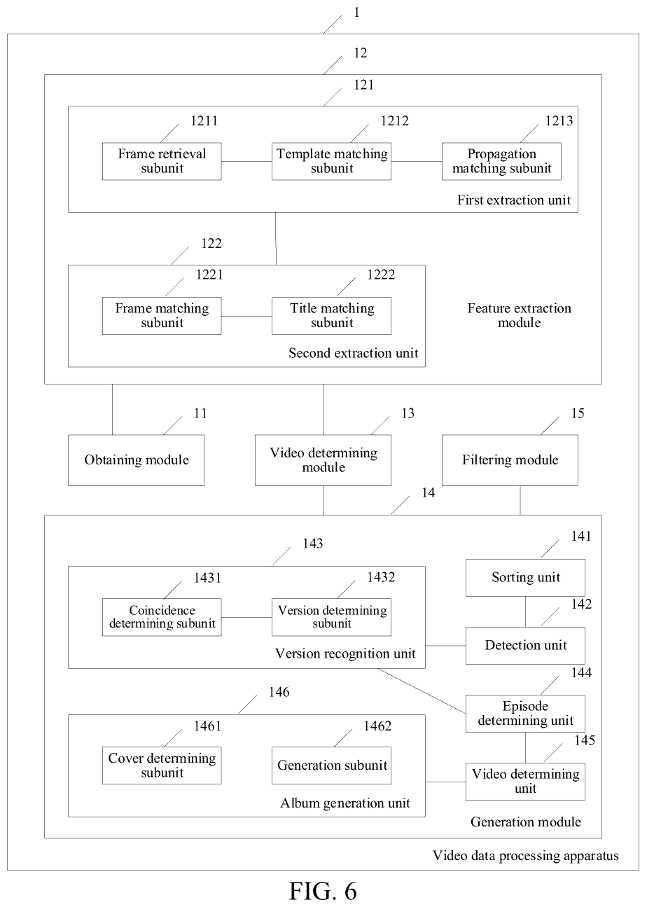

Referring to FIG. 7, FIG. 7 is a schematic structural diagram of a computer device according to an embodiment of this application. As shown in FIG. 7, the video data processing apparatus 1 in the foregoing embodiment corresponding to FIG. 6 may be applied to a computer device 1000. The computer device 1000 may include: a processor 1001, a network interface 1004, and a memory 1005. In addition, the foregoing computer device 1000 may further include: a user interface 1003 and at least one communications bus 1002. The communications bus 1002 is configured to implement the connection and communication among the components. The user interface 1003 may include a display and a keyboard. In some embodiments, the user interface 1003 may further include a standard wired interface and a standard wireless interface. In some embodiments, the network interface 1004 may include a standard wired interface and a standard wireless interface (such as a WI-FI interface). The memory 1005 may be a high-speed random access memory (RAM), or may be a non-volatile memory, for example, at least one magnetic disk storage. In some embodiments, the memory 1005 may further be at least one storage apparatus that is located far away from the above processor 1001. As shown in FIG. 7, as a computer-readable storage medium, the memory 1005 may include an operating system, a network communication module, a user interface module, and a device control application program.

In the computer device 1000 shown in FIG. 7, the network interface 1004 may provide a network communication element. The user interface 1003 is mainly configured to provide an input interface for a user. The processor 1001 may be configured to invoke the device control application program stored in the memory 1005 to implement:
obtaining M to-be-processed videos, M being a positive integer.
performing feature extraction on the M to-be-processed videos to obtain video attribute information corresponding to the to-be-processed videos, and obtaining source label information corresponding to the to-be-processed videos, the video attribute information including work attribute information and episode attribute information;

classifying the M to-be-processed videos according to the source label information to obtain initial video sets, and determining to-be-processed videos having target work attribute information in the initial video sets as to-be-sorted videos, the to-be-processed videos in the initial video set having the same source label information; and the work attribute information related to the M to-be-processed videos including the target work attribute information; and

sorting the to-be-sorted videos according to episode attribute information corresponding to the to-be-sorted videos to obtain sorted videos, determining the sorted videos as ordered album videos if the episode attribute information corresponding to the sorted videos satisfies an episode legitimacy condition, and generating a video album set containing the ordered album videos, the video album set being configured for being displayed in a query result display box when query data matches work attribute information or source label information corresponding to the ordered album videos.

The computer device 1000 described in the embodiments of this application may perform the descriptions of the video data processing method in the foregoing embodiments corresponding to any one of FIG. 3 and FIG. 5, and details are not described herein again. In addition, the description of beneficial effects of the same method are not described herein again.

In addition, the embodiments of this application further provide a computer-readable storage medium, having a computer program executed by the foregoing video data processing apparatus 1 stored therein, and the computer program includes a program instruction. When executing the foregoing program instruction, the foregoing processor can perform the descriptions of the video data processing method in the foregoing embodiments corresponding to any one of FIG. 3 and FIG. 5. Therefore, details are not described herein again. In addition, the description of beneficial effects of the same method are not described herein again. For technical details that are not disclosed in the computer-readable storage medium embodiment of this application, reference may be made to the descriptions of the method embodiments of this application.

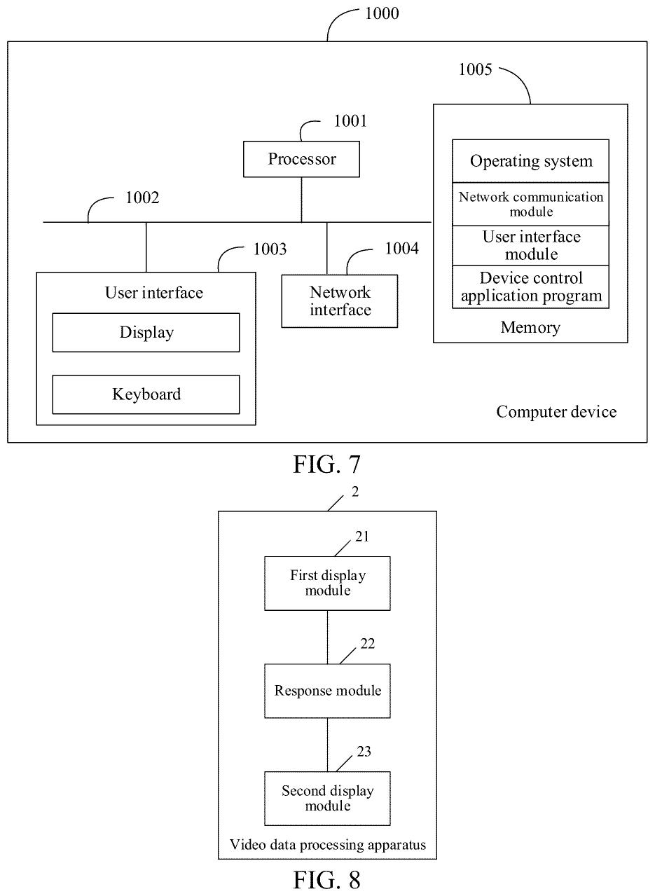

Further, referring to FIG. 8, FIG. 8 is a schematic structural diagram of another video data processing apparatus according to an embodiment of this application. The foregoing video data processing apparatus may be a computer program (including a program code) running in a computer device. For example, the video data processing apparatus is application software. The apparatus may be configured to perform corresponding operations in the method provided by the embodiments of this application. As shown in FIG. 8, a video data processing apparatus 2 may include: a first display module 21, a response module 22, and a second display module 23.

The first display module 21 is configured to display inputted target query data in a query box of an application page.

The response module 22 is configured to respond to a trigger operation for the target query data and display a recommendation result display region in a query result display box of the application page if an intention type of the target query data is a video intention type.

The second display module 23 is configured to sequentially display ordered album videos contained in a target video album set in the recommendation result display region. The target video album set is a video album set whose work attribute information or source label information matches the target query data and includes ordered album videos corresponding to one or more pieces of work attribute information. A display order of ordered album videos having the same work attribute information is sorted according to an episode order of corresponding episode attribute information. The ordered album video in the target video album set is of a commentary video type.

For the specific functional implementations of the first display module 21, the response module 22, and the second display module 23, reference may be made to the scene description in the embodiment corresponding to FIG. 2B, and details are not described herein again.

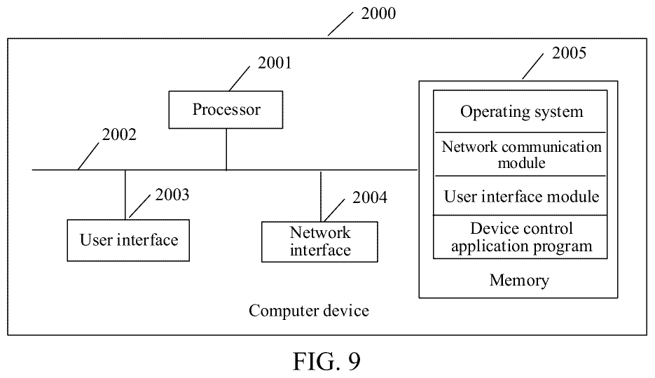

Further, referring to FIG. 9, FIG. 9 is a schematic structural diagram of another computer device according to an embodiment of this application. As shown in FIG. 9, the video data processing apparatus 2 in the foregoing embodiment corresponding to FIG. 8 may be applied to a computer device 2000. The computer device 2000 may include: a processor 2001, a network interface 2004, and a memory 2005. In addition, the foregoing computer device 2000 further includes: a user interface 2003 and at least one communications bus 2002. The communications bus 2002 is configured to implement the connection and communication among the components. The user interface 2003 may include a display and a keyboard. In some embodiments, the user interface 2003 may further include a standard wired interface and a standard wireless interface. In some embodiments, the network interface 2004 may include a standard wired interface and a standard wireless interface (such as a WI-FI interface). The memory 2005 may be a high-speed RAM, or may be a non-volatile memory, for example, at least one magnetic disk storage. In some embodiments, the memory 2005 may further be at least one storage apparatus that is located far away from the above processor 2001. As shown in FIG. 9, as a computer-readable storage medium, the memory 2005 may include an operating system, a network communication module, a user interface module, and a device control application program.

In the computer device 2000 shown in FIG. 9, the network interface 2004 may provide a network communication function. The user interface 2003 is mainly configured to provide an input interface for a user. The processor 2001 may be configured to invoke the device control application program stored in the memory 2005 to implement:
displaying inputted target query data in a query box of an application page;
responding to a trigger operation for the target query data, and displaying a recommendation result display region in a query result display box of the application page if an intention type of the target query data is a video intention type; and
sequentially displaying ordered album videos contained in a target video album set in the recommendation result display region, the target video album set being a video album set whose work attribute information or source label information matches the target query data and including ordered album videos corresponding to one or more pieces of work attribute information; a display order of ordered album videos having the same work attribute information being sorted according to an episode order of corresponding episode attribute information; and the ordered album video in the target video album set being of a commentary video type.

The computer device 2000 described in the embodiments of this application may perform the descriptions of the video data processing method in the foregoing embodiments, or may perform the descriptions of the video data processing apparatus 2 in the foregoing embodiments corresponding to FIG. 3 and FIG. 5. Details are not described herein again. In addition, the description of beneficial effects of the same method are not described herein again.

In addition, the embodiments of this application further provide a computer-readable storage medium, having a computer program executed by the foregoing video data processing apparatus 2 stored therein. When loading and executing the foregoing computer program, the foregoing processor can perform the descriptions of the video data processing method in any one of the foregoing embodiments. Therefore, details are not described herein again. In addition, the description of beneficial effects of the same method are not described herein again. For technical details that are not disclosed in the computer-readable storage medium embodiment of this application, reference may be made to the descriptions of the method embodiments of this application.

The foregoing computer-readable storage medium may be an internal storage unit of the video data processing apparatus provided by any one of the foregoing embodiments or an internal storage unit of the foregoing computer device, for example, a hard disk or memory of the computer device. The computer-readable storage medium may further be an external storage device of the computer device, for example, a plug-in hard disk, a smart media card (SM C), a secure digital (SD) card, and a flash card that are equipped in the computer device. Further, the computer-readable storage medium may further include both the internal storage unit and the external storage device of the computer device. The computer-readable storage medium is configured to store the computer program and other programs and data required by the computer device. The computer-readable storage medium may further be configured to temporarily store data that has been outputted or is to be outputted.

In addition, the embodiments of this application further provide a computer program product or a computer program, including a computer instruction. The computer instruction is stored in a computer-readable storage medium. A processor of a computer device reads the computer instruction from the computer-readable storage medium and executes the computer instruction so that the computer device performs the method provided in the foregoing embodiment corresponding to any one of FIG. 3 and FIG. 5.

In the specification, claims, and accompanying drawings of this application, the terms “first,” “second,” and so on are intended to distinguish different objects but do not indicate a particular order. In addition, the term “include” and any variant thereof are intended to cover a non-exclusive inclusion. For example, processes, methods, apparatuses, products, or devices including a series of steps or units are not limited to the listed steps or units, but instead, include other steps or units not listed in some embodiments, or include other steps or units inherent to these processes, methods, apparatuses, products, or devices in some embodiments.

A person skilled in the art may realize that the exemplary units and algorithm steps described in conjunction with the embodiments disclosed herein may be implemented in electronic hardware, computer software, or a combination of the two. To clearly illustrate the interchangeability of hardware and software, the composite and steps of the examples have been described above generally according to the network elements. Whether the network elements are executed in a mode of hardware or software depends on particular application and design constraint conditions of the technical solutions. A person skilled in the art may use different methods for the particular application to implement the described network elements, but such implementations shall not be considered outside the scope of this application.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A video data processing method comprising:
obtaining one or more candidate videos;
performing feature extraction on each of the one or more candidate videos to obtain video attribute information corresponding to each candidate video, and obtaining source label information corresponding to each candidate video, the video attribute information including work attribute information and episode attribute information;
classifying the one or more candidate videos according to the source label information to obtain an initial video set, the initial video set containing at least one candidate video having same source label information;
determining one or more candidate videos, in the initial video set, that have target work attribute information as one or more target videos;
sorting the one or more target videos according to episode attribute information corresponding to the one or more target videos to obtain one or more sorted videos; and
in response to the episode attribute information corresponding to the one or more sorted videos satisfying an episode legitimacy condition, determining the one or more sorted videos as one or more ordered album videos and generating a video album set containing the one or more ordered album videos.

2. The method according to claim 1, wherein performing the feature extraction includes, for one candidate video of the one or more candidate videos:
performing work attribute extraction on the one candidate video to obtain work attribute information corresponding to the one candidate video; and
performing episode attribute extraction on the one candidate video to obtain episode attribute information corresponding to the one candidate video.

3. The method according to claim 2, wherein performing the work attribute extraction on the one candidate video includes:
sampling the one candidate video to obtain a video frame image;
performing picture matching on the video frame image against one or more video works in a video work library to obtain a picture similarity between each of the one or more video works and the video frame image;
determining a video work having a highest picture similarity with the video frame image as a target video work; and
determining video work attribute information corresponding to the target video work as the work attribute information corresponding to the one candidate video in response to the picture similarity corresponding to the target video work being greater than or equal to a picture similarity threshold.

4. The method according to claim 2, wherein performing the work attribute extraction on the one candidate video includes:
sampling the one candidate video at equal intervals to obtain a plurality of video frame images;
for each of the plurality of video frame images:
performing picture matching on the video frame image against one or more video works in a video work library to obtain a picture similarity between each of the one or more video works and the video frame image; and
marking a candidate video work for determination corresponding to the video frame image, the candidate video work having a highest picture similarity with the video frame image among the one or more video works in the video work library; and
after picture matching and candidate video work marking have been performed for all of the plurality of video frame images, determining video work attribute information corresponding to one candidate video work that has a largest marking count as the work attribute information corresponding to the one candidate video.

5. The method according to claim 2, wherein performing the work attribute extraction on the one candidate video includes:
obtaining video title information corresponding to the one candidate video;
performing structural matching on the video title information against one or more title templates in a title template library to obtain a structural similarity between each of the one or more title templates and the video title information;
determining a title template having a highest structural similarity with the video title information as a target title template; and
performing information extraction on the video title information according to the target title template to obtain the work attribute information corresponding to the one candidate video in response to the structural similarity between the video title information and the target title template being greater than or equal to a structural similarity threshold.

6. The method according to claim 2, wherein performing the work attribute extraction on the one candidate video includes, for one sample video in a sample video library:
performing picture matching on the one candidate video and the one sample video to obtain a video picture similarity;
performing similarity calculation on video title information of the one candidate video and video title information corresponding to the one sample video to obtain a video title similarity;
performing click analysis on video click logs associated with the one candidate video and the one sample video to obtain a video click similarity;
determining a video similarity between the one candidate video and the one sample video according to the video picture similarity, the video title similarity, and the video click similarity;
weighting a video work confidence of the one sample video for an associated work according to the video similarity to obtain a work confidence of the one candidate video for the associated work in response to the video similarity being greater than a video similarity threshold, the video work confidence of the one sample video for the associated work characterizing a credibility of the one sample video belonging to the associated work; and
determining video work attribute information corresponding to the associated work as the work attribute information corresponding to the one candidate video in response to the work confidence being greater than or equal to a work confidence threshold.

7. The method according to claim 2, wherein performing the episode attribute extraction on the one candidate video includes:
obtaining a candidate video work for matching from a video work library, the candidate video work having the work attribute information corresponding to the one candidate video;
sampling the one candidate video to obtain a video frame image;
performing picture matching on the video frame image against one or more video work pictures in the candidate video work to obtain a video work picture matching the video frame image; and
determining episode information corresponding to the video work picture matching the video frame image as the episode attribute information corresponding to the one candidate video.

8. The method according to claim 2, wherein performing the episode attribute extraction on the one candidate video includes:
performing video layout character recognition on a cover image of the one candidate video to obtain cover title information corresponding to the one candidate video;
performing structural matching on the cover title information against one or more episode templates in an episode template library to obtain a structural similarity between each of the one or more episode templates and the cover title information;
determining an episode template having a highest structural similarity with the cover title information as a target episode template; and
performing information extraction on the cover title information according to the target episode template to obtain the episode attribute information corresponding to the one candidate video in response to the structural similarity between the cover title information and the target episode template being greater than or equal to a structural similarity threshold.

9. The method according to claim 1, further comprising:
performing continuity detection on the episode attribute information corresponding to the one or more sorted videos to obtain a continuity detection result;
performing video version recognition on the one or more sorted videos according to a target work knowledge graph to obtain a target video version corresponding to the one or more sorted videos in response to the continuity detection result being an episode continuity result, the target work knowledge graph being associated with work attribute information corresponding to the one or more sorted videos;
determining, in the target work knowledge graph, total episode information corresponding to the one or more sorted videos according to the target video version; and
determining that the episode attribute information corresponding to the one or more sorted videos satisfies the episode legitimacy condition in response to largest episode attribute information in the episode attribute information corresponding to the one or more sorted videos being same as the total episode information.

10. The method according to claim 9, wherein:
the target work knowledge graph contains one or more video versions and one or more video object lists each corresponding to one of the one or more video versions; and
performing the video version recognition on the one or more sorted videos includes:
performing object recognition on the one or more sorted video to obtain a plurality of video objects contained in the one or more sorted video and occurrence durations each corresponding to one of the video objects;
obtaining one or more target video objects from the plurality of video objects according to a duration order of the occurrence durations;
determining an object coincidence degree between each of the one or more target video objects and each of the one or more video object lists, the object coincidence degree between one target video object and one video object list being a coincidence degree between one or more video objects contained in the one video object list and the one target video object; and
determining a video version corresponding to a video object list having a largest object coincidence degree as the target video version corresponding to the one or more sorted videos.

11. The method according to claim 1, wherein:
the one or more ordered album videos include at least two ordered album videos; and
generating the video album set includes:
for one ordered album video or the at least two ordered album videos:
performing correlation matching on a video cover corresponding to the one ordered album video and a video title corresponding to the one ordered album video to obtain a correlation matching result;
determining the video cover corresponding to the one ordered album video as an album video cover corresponding to the one ordered album video in response to the correlation matching result being a correlation matching success result; and
in response to the correlation matching result being a correlation matching failure result, performing video frame screening on the one ordered album video to obtain a video frame picture matching the video title corresponding to the one ordered album video, and determining the video frame picture as the album video cover corresponding to the one ordered album video; and
generating, after the album video cover corresponding to each of the at least two ordered album videos has been obtained, the video album set containing the album video covers corresponding to the at least two ordered album videos.

12. The method according to claim 1, further comprising:
obtaining a first initial video set;
performing black border detection on the first initial video set to obtain a black border ratio corresponding to each initial video in the first initial video set;
filtering out initial videos with a black border ratio greater than a black border ratio threshold from the first initial video set to obtain a second initial video set;
performing watermark detection on the second initial video set to obtain a watermark area ratio corresponding to each initial video in the second initial video set;
filtering out initial videos with a watermark area ratio greater than a watermark area ratio threshold from the second initial video set to obtain a third initial video set;
performing definition recognition on the third initial video set to obtain a definition corresponding to each initial video in the third initial video set; and
filtering out initial videos with a definition below a definition threshold from the third initial video set to obtain the one or more candidate videos.

13. A non-transitory computer-readable storage medium storing a computer program that, when executed by a processor, causes the processor to perform the method according to claim 1.

14. A computer device comprising:
a processor; and
a memory storing program codes that, when executed by the processor, cause the processor to:
obtain one or more candidate videos;
perform feature extraction on each of the one or more candidate videos to obtain video attribute information corresponding to each candidate video, and obtain source label information corresponding to each candidate video, the video attribute information including work attribute information and episode attribute information;
classify the one or more candidate videos according to the source label information to obtain an initial video set, the initial video set containing at least one candidate video having same source label information;
determine one or more candidate videos, in the initial video set, that have target work attribute information as one or more target videos;
sort the one or more target videos according to episode attribute information corresponding to the one or more target videos to obtain one or more sorted videos; and
in response to the episode attribute information corresponding to the one or more sorted videos satisfying an episode legitimacy condition, determine the one or more sorted videos as one or more ordered album videos and generate a video album set containing the one or more ordered album videos.

15. The computer device according to claim 14, wherein the program codes, when executed by the processor, further cause the processor to, when performing the feature extraction, for one candidate video of the one or more candidate videos:
perform work attribute extraction on the one candidate video to obtain work attribute information corresponding to the one candidate video; and
perform episode attribute extraction on the one candidate video to obtain episode attribute information corresponding to the one candidate video.

16. The computer device according to claim 15, wherein the program codes, when executed by the processor, further cause the processor to, when performing the feature extraction performing the work attribute extraction on the one candidate video includes:
sample the one candidate video to obtain a video frame image;
perform picture matching on the video frame image against one or more video works in a video work library to obtain a picture similarity between each of the one or more video works and the video frame image;
determine a video work having a highest picture similarity with the video frame image as a target video work; and
determine video work attribute information corresponding to the target video work as the work attribute information corresponding to the one candidate video in response to the picture similarity corresponding to the target video work being greater than or equal to a picture similarity threshold.

17. The computer device according to claim 15, wherein the program codes, when executed by the processor, further cause the processor to, when performing the work attribute extraction on the one candidate video includes:
sample the one candidate video at equal intervals to obtain a plurality of video frame images;
for each of the plurality of video frame images:
perform picture matching on the video frame image against one or more video works in a video work library to obtain a picture similarity between each of the one or more video works and the video frame image; and
mark a candidate video work for determination corresponding to the video frame image, the candidate video work having a highest picture similarity with the video frame image among the one or more video works in the video work library; and
after picture matching and candidate video work marking have been performed for all of the plurality of video frame images, determine video work attribute information corresponding to one candidate video work that has a largest marking count as the work attribute information corresponding to the one candidate video.

18. A video data processing method comprising:
displaying inputted target query data in a query box of an application page;
responding to a trigger operation for the target query data to display a recommendation result display region in a query result display box of the application page in response to an intention type of the target query data being a video intention type; and
sequentially displaying one or more ordered album videos contained in a target video album set in the recommendation result display region, the target video album set being a video album set with work attribute information or source label information matching the target query data and including ordered album videos corresponding to one or more pieces of work attribute information, a display order of ordered album videos having same work attribute information being according to an episode order of corresponding episode attribute information, and the ordered album video in the target video album set being of a commentary video type.

19. A non-transitory computer-readable storage medium storing a computer program that, when executed by a processor, causes the processor to perform the method according to claim 18.

20. A computer device comprising:
a processor; and
a memory storing program codes that, when executed by the processor, cause the processor to perform the method according to claim 18.
